(19) United States
(12) Patent Application Publication
(10) Pub. No.: US 2024/0383676 A1
(43) Pub. Date: Nov. 21, 2024

(54) WASTE COLLECTION ASSEMBLY, WASTE COLLECTION VEHICLE AND METHOD FOR OPERATING SAME

(71) Applicant: Eric BOIVIN, Levis (CA)

(72) Inventor: Eric BOIVIN, Levis (CA)

(21) Appl. No.: 18/722,057

(22) PCT Filed: Dec. 20, 2022
(86) PCT No.: PCT/CA2022/051866

§ 371 Date: Jun. 20, 2024

Related U.S. Application Data
(60) Provisional application No. 63/291,638, filed on Dec. 20, 2021.

(51) Int. Cl. B65F 3/22

(52) U.S. Cl. CPC B65F 3/22

(57) ABSTRACT

A waste collection assembly has a container defining an opening; a longitudinally extending passageway extending from the container, a portion of the passageway extending from the container defining a hopper; and a conveyor system disposed at least in part in the passageway, the conveyor system being configured to operate in a first direction and in a second direction. A vehicle having the waste collection assembly and a method for operating the waste collection assembly are also disclosed.

### CROSS-REFERENCE

The present application claims priority from U.S. Provisional Patent Application No. 63/291,638, filed Dec. 20, 2021, the entirety of which is incorporated herein by reference.

### TECHNICAL FIELD

The present technology relates to waste collection assemblies and waste collection vehicles having a conveyor system and to methods for operating these.

### BACKGROUND

Waste collection vehicles provided with an auger conveyor system are known. In some such vehicles, the auger conveyor system conveys waste to the container of the vehicle. Once the container is full, a door provided on the back of container is opened and the container is tipped in order to empty the waste from the container.

Although such waste collection vehicles achieve their intended purposes, the mechanisms used to open and close the door and to tip the container add a lot of weight to the vehicle. Constantly carrying this weight as part of the vehicle requires energy when the vehicle does a waste collection run. This means more fuel consumption for vehicles powered by an internal combustion engine, which translates into high operation costs. For electric powered vehicles, this means reduced range or a larger battery pack which adds weight and higher acquisition costs for the vehicle. Furthermore, having the door provided at the back of the container means that the container should only be unloaded in certain controlled environments in order to safely do so as the vison of the operator of the vehicle at the back of the vehicle is limited.

Therefore, there is a desire for a waste collection vehicle that can overcome at least some of the above-described drawbacks.

### SUMMARY

It is an object of the present technology to ameliorate at least some of the inconveniences present in the prior art.

According to an aspect of the present technology, there is provided a waste collection assembly having: a container defining a lower opening; a longitudinally extending passageway extending under the container, the passageway extending from the container, a portion of the passageway extending from the container defining a hopper; and a conveyor system disposed at least in part in the passageway. The conveyor system is configured to operate in a first direction and in a second direction. In the first direction, the conveyor system conveys waste from the hopper, through the passageway under the container, and into the container via the lower opening of the container. In the second direction, the conveyor system conveys waste received from the container via the lower opening of the container, through the passageway under the container, through the hopper and out of an end of the passageway.

In some embodiments, the conveyor system is an auger conveyor system.

In some embodiments, the auger conveyor system has: at least one auger disposed in the passageway; and a motor operatively connected to an end of the at least one auger for driving the at least one auger.

In some embodiments, the at least one auger is two counter-rotating augers.

In some embodiments, a gate is operatively connected to the end the passageway for selectively opening and closing the end of the passageway.

In some embodiments, an auger support is connected to an inner side of the gate. The end of the at least one auger operatively connected to the motor is a first end. The auger support supports a second end of the at least one auger when the gate is closed.

In some embodiments, the auger support is at least one peg received in the second end of the at least one auger when the gate is closed.

In some embodiments, a diameter of a blade of the at least one auger is smaller at a rear of the at least one auger than at a front of the at least one auger.

In some embodiments, the container is a rotatable container having an internal helical flange.

In some embodiments, the at least one auger is a single auger.

In some embodiments, the container and the auger rotate in opposite directions.

In some embodiments, auger and the internal helical flange have opposite handedness.

In some embodiments, the container and the auger rotate at different speeds.

In some embodiments, the auger rotates faster than the container.

In some embodiments, the auger has a shaft extending in the container; and the container rotates about the shaft.

In some embodiments, the motor is operatively connected to the container for driving the container.

In some embodiments, a planetary gear system operatively connecting the motor to the container.

In some embodiments, a sun gear of the planetary gear system is mounted to and rotates with the shaft.

In some embodiments, the shaft is angled such that an end of the shaft connected to the motor is vertically higher than an end of the shaft disposed in the hopper.

In some embodiments, the conveyor system has: a conveyor having steps moveable between an extended position and a retracted position; a track, a portion of each of steps being received in the track; and an actuator operatively connected to the steps for moving the steps around the track, the steps moving between the extended and retracted positions as the steps move around the track such that steps located in the hopper are in the extended position and steps located under the lower opening of the container are in the retracted position.

In some embodiments, a ramp is disposed over the conveyor and is at least partially aligned with a rear portion of the lower opening of the container. The ramp directs waste present on the steps in the retracted position into the container via the lower opening.

In some embodiments, the conveyor has slats. The slats and steps are disposed in an alternating arrangement. The actuator moves the slats with the steps. For each slat and each step, a top surface of the slat is generally level with a top surface of the step adjacent thereto when the step is in the retracted position.

In some embodiments, each slat has a scraper connected thereto. The scraper extends from one side of the slat to abut an arcuate surface of the step adjacent to the slat.

In some embodiments, the conveyor system has: a packer; and at least one drive assembly operatively connected to the packer for moving the packer in the passageway. In the first direction, the at least one drive assembly moves the packer away from the hopper and toward the lower opening of the container. In the second direction, the at least one drive assembly moves the packer away from the lower opening of the container and toward the hopper.

In some embodiments, the at least one drive assembly includes a first drive assembly and a second drive assembly. The packer has a first portion operatively connected to the first drive assembly and a second portion operatively connected to the second drive assembly. The packer has a lowered configuration and a raised configuration. At least one of the first and second drive assemblies moves the first and second portions of the packer relative to each other to change the packer from one of the lowered and raised configurations to another one of the lowered and raised configurations. The first and second drive assemblies moving the first and second portions of the packer in a same direction for moving the packer in the passageway.

In some embodiments, each of the first and second drive assemblies has: a first sprocket; a second sprocket, the first sprocket being disposed closer to the hopper than the second sprocket; a chain engaging the first and second sprockets; and a motor operatively connected to one of the first and second sprockets for driving the one of the first and second sprockets. The first portion of the packer is operatively connected to the chain of the first drive assembly. The second portion of the packer is operatively connected to the chain of the second drive assembly.

In some embodiments, the motor of the first drive assembly is operatively connected to the second sprocket of the first drive assembly; and the motor of the second drive assembly is operatively connected to the first sprocket of the second drive assembly.

In some embodiments, the first and second portions of the packer are hinged.

In some embodiments, a first scrapper is pivotally connected to the first portion of the packer; and a second scraper is pivotally connected to the second portion of the packer.

In some embodiments, sidewalls of the container extend laterally inwardly as they extend upwardly.

In some embodiments, an automatic side loader is disposed to a side of the hopper.

In some embodiments, a gate is operatively connected to the end of the passageway for selectively opening and closing the end of the passageway.

According to another aspect of the present technology, there is provided a waste collection vehicle having: a cab; at least three wheels operatively connected to the cab; and a waste collection assembly according to any of the above. The container is disposed at least in part behind the cab.

In some embodiments, the passageway extends under the cab and forward of the cab. The portion of the passageway extending forward of the cab defines the hopper. In the first direction, the conveyor system conveys waste from the hopper, through the passageway under the cab and the container, and into the container via the lower opening of the container. In the second direction, the conveyor system conveys waste received from the container via the lower opening of the container, through the passageway under the container and the cab, through the hopper and out of a front of the passageway.

In some embodiments, the at least three wheels include two rear wheels; and a width of the container is less than a lateral distance between the two rear wheels.

In some embodiments, at least one actuator is operatively connected to the wheels for lifting the end of the passageway.

In some embodiments, at least one actuator comprises cylinders of suspension assemblies of the vehicle.

In some embodiments, at least one electric motor is operatively connected to at least one of the at least three wheels for driving the at least one of the at least three wheels.

In some embodiments, a top of the container is lower than a top of the cab.

In some embodiments, a portion of the container extends under a portion of the cab.

According to another aspect of the present technology, there is provided a waste collection vehicle having: a cab; at least three wheels operatively connected to the cab; a container disposed at least in part behind the cab, the container defining an opening; a longitudinally extending passageway extending under the cab, the passageway extending forward of the cab, a portion of the passageway extending forward of the cab defining a hopper; and a conveyor system disposed at least in part in the passageway, the conveyor system being configured to operate in a first direction and in a second direction. In the first direction, the conveyor system conveys waste from the hopper, through the passageway under the cab, and into the container via the opening of the container. In the second direction, the conveyor system conveys waste received from the container via the opening of the container, through the passageway under the cab, through the hopper and out of a front of the passageway.

In some embodiments, the passageway extends under the container. In the first direction, the conveyor system conveys waste from the hopper, through the passageway under the cab and the container, and into the container via the opening of the container. In the second direction, the conveyor system conveys waste received from the container via the opening of the container, through the passageway under the container and the cab, through the hopper and out of the front of the passageway.

In some embodiments, the conveyor system is an auger conveyor system.

In some embodiments, the auger conveyor system has: at least one auger disposed in the passageway; and a motor operatively connected to a rear end of the at least one auger for driving the at least one auger.

In some embodiments, the at least one auger is two counter-rotating augers.

In some embodiments, a front gate is operatively connected to a front of the passageway for selectively opening and closing the front of the passageway.

In some embodiments, an auger support is connected to a rear side of the front gate. The auger support supports a front end of the at least one auger when the front gate is closed.

In some embodiments, the auger support is at least one peg received in the front end of the at least one auger when the front gate is closed.

In some embodiments, a diameter of a blade of the at least one auger is smaller at a rear of the at least one auger than at a front of the at least one auger.

In some embodiments, the container is a rotatable container having an internal helical flange.

In some embodiments, the at least one auger is a single auger.

In some embodiments, the container and the auger rotate in opposite directions.

In some embodiments, the auger and the internal helical flange have opposite handedness.

In some embodiments, the container and the auger rotate at different speeds.

In some embodiments, the auger rotates faster than the container.

In some embodiments, the auger has a shaft extending in the container; and the container rotates about the shaft.

In some embodiments, the motor is operatively connected to the container for driving the container.

In some embodiments, a planetary gear system operatively connects the motor to the container.

In some embodiments, a sun gear of the planetary gear system is mounted to and rotates with the shaft.

In some embodiments, the shaft is angled such that a rear end of the shaft is vertically higher than a front end of the shaft.

In some embodiments, the conveyor system has: a conveyor having steps moveable between an extended position and a retracted position; a track, a portion of each of steps being received in the track; and an actuator operatively connected to the steps for moving the steps around the track. The steps move between the extended and retracted positions as the steps move around the track such that steps located in the hopper are in the extended position and steps located under the lower opening of the container are in the retracted position.

In some embodiments, a ramp is disposed over the conveyor and is at least partially aligned with a rear portion of the opening of the container. The ramp directs waste present on the steps in the retracted position into the container via the opening.

In some embodiments, the conveyor has slats. The slats and steps are disposed in an alternating arrangement. The actuator moves the slats with the steps. For each slat and each step, a top surface of the slat is generally level with a top surface of the step adjacent thereto when the step is in the retracted position.

In some embodiments, each slat has a scraper connected thereto. The scraper extends from one side of the slat to abut an arcuate surface of the step adjacent to the slat.

In some embodiments, the conveyor system has: a packer; and at least one drive assembly operatively connected to the packer for moving the packer in the passageway. In the first direction, the at least one drive assembly moves the packer away from the hopper and toward the opening of the container. In the second direction, the at least one drive assembly moving the packer away from the opening of the container and toward the hopper.

In some embodiments, the at least one drive assembly includes a first drive assembly and a second drive assembly; the packer has a front portion operatively connected to the first drive assembly and a rear portion operatively connected to the second drive assembly; the packer has a lowered configuration and a raised configuration; at least one of the first and second drive assemblies moving the front and rear portions of the packer relative to each other to change the packer from one of the lowered and raised configurations to another one of the lowered and raised configurations; and the first and second drive assemblies moving the front and rear portions of the packer in a same direction for moving the packer in the passageway.

In some embodiments, each of the first and second drive assemblies has: a front sprocket; a rear sprocket; a chain engaging the front and rear sprockets; and a motor operatively connected to one of the front and rear sprockets for driving the one of the front and rear sprockets. The front portion of the packer is operatively connected to the chain of the first drive assembly. The rear portion of the packer is operatively connected to the chain of the second drive assembly.

In some embodiments, the motor of the first drive assembly is operatively connected to the rear sprocket of the first drive assembly; and the motor of the second actuator is operatively connected to the front sprocket of the second drive assembly.

In some embodiments, the front and rear portions of the packer are hinged.

In some embodiments, a front scrapper is pivotally connected to the front portion of the packer; and a rear scraper is pivotally connected to the rear portion of the packer.

In some embodiments, sidewalls of the container extend laterally inwardly as they extend upwardly.

In some embodiments, the at least three wheels comprise two front wheels and two rear wheels.

In some embodiments, a width of the container is less than a lateral distance between the two rear wheels.

In some embodiments, at least one actuator is operatively connected to the front wheels for lifting the front of the passageway.

In some embodiments, the at least one actuator comprises cylinders of front suspension assemblies of the vehicle.

In some embodiments, at least one electric motor is operatively connected to at least one of the at least three wheels for driving the at least one of the at least three wheels.

In some embodiments, a top of the container is lower than a top of the cab.

In some embodiments, a front portion of the container extends under a rear portion of the cab.

In some embodiments, an automatic side loader is disposed to a side of the hopper.

In some embodiments, a front gate is operatively connected to a front of the passageway for selectively opening and closing the front of the passageway.

According to another aspect of the present technology, there is provided a method for operating a waste collection assembly. The waste collection assembly has a container defining a lower opening. The method comprises: selecting an operation mode of a conveyor system of the waste collection assembly, the operation mode being selected from a loading mode and an unloading mode; in response to selecting the loading mode, operating the conveyor system in the loading mode, in the loading mode: the conveyor system operates in a first direction conveying waste from a hopper toward the container by making waste pass under the container and into the container via the lower opening of the container; and in response to selecting the unloading mode, operating the conveyor system in the unloading mode, in the unloading mode: the conveyor system operates in a second direction conveying waste received from the container via the lower opening of the container toward the hopper by making waste pass under the container, into the hopper, and out of the hopper.

In some embodiments, the method further comprises: closing a gate of the hopper prior to operating the conveyor system in the loading mode; and opening the gate prior to operating the conveyor system in the unloading mode.

In some embodiments, the method further comprises lifting an end of the waste collection assembly having the hopper prior to operating the waste collection assembly in the unloading mode.

In some embodiments, the method further comprises putting waste in the hopper using an automatic side loader.

According to another aspect of the present technology, there is provided a method for operating a waste collection vehicle. The waste collection vehicle has a cab, at least three wheels operatively connected to the cab, and a container disposed at least in part behind the cab. The container defines an opening. The method comprises: selecting an operation mode of a conveyor system of the vehicle, the operation mode being selected from a loading mode and an unloading mode; in response to selecting the loading mode, operating the conveyor system in the loading mode, in the loading mode: the conveyor system operates in a first direction conveying waste from a hopper disposed forward of the cab toward a back of the vehicle by making waste pass under the cab and into the container via the opening of the container; and in response to selecting the unloading mode, operating the conveyor system in the unloading mode, in the unloading mode: the conveyor system operates in a second direction conveying waste received from the container via the opening of the container toward a front of the vehicle by making waste pass under the cab, into the hopper, and out of a front of the vehicle.

In some embodiments, the method further comprises: closing a front gate prior to operating the conveyor system in the loading mode, the front gate being disposed in front of the hopper; and opening the front gate prior to operating the conveyor system in the unloading mode.

In some embodiments, the method further comprises lifting a front of the vehicle prior to operating the vehicle in the unloading mode.

In some embodiments, the method further comprises putting waste in the hopper using an automatic side loader.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a waste collection vehicle;

FIG. 2 is a front elevation view of the vehicle of FIG. 1, with a front gate opened;

FIG. 3 is a rear elevation view of the vehicle of FIG. 1;

FIG. 4 is a top elevation view of the vehicle of FIG. 1;

FIG. 5 is a cross-sectional view of the vehicle of FIG. 1 taken through line 5-5 of FIG. 4;

FIG. 6 is a perspective view, taken from a front, right side, of the vehicle of FIG. 1 with the front gate opened;

FIG. 7 is a perspective view, taken from a front, left side, of an alternative embodiment of the vehicle of FIG. 1;

FIG. 8 is a side elevation view of the vehicle of FIG. 1 in position for unloading the waste from its container into another larger waste collection vehicle;

FIG. 9 is a right side elevation view of the vehicle of FIG. 1 where a front of the vehicle is raised in order to permit unloading of the waste from its container;

FIG. 10 is a perspective view, taken from a front, right side, of an alternative embodiment of the vehicle of FIG. 1;

FIG. 11 is a perspective view of a longitudinal cross-section of a portion of a conveyor system of the vehicle of FIG. 10;

FIG. 12 is a perspective view taken from a front, right side of a portion of the conveyor system of the vehicle of FIG. 10 showing a position of slats and steps of the conveyor system at the front of the conveyor system;

FIG. 13 is a right side elevation view of two steps and one slat in the position shown in FIG. 12;

FIG. 14 is a perspective view taken from a front, right side of a portion of the conveyor system of the vehicle of FIG. 10 showing a position of slats and steps of the conveyor system near a rear of the conveyor system;

FIG. 15 is a right side elevation view of two steps and one slat in the position shown in FIG. 14;

FIG. 16 is a perspective view, taken from a front, left side, of an alternative embodiment of the vehicle of FIG. 1;

FIG. 17 is another perspective view, taken from a front, left side, of the vehicle of FIG. 16;

FIG. 18 is a longitudinal cross-section of the vehicle of FIG. 16, with a packer in a lowered configuration;

FIG. 19 is a left side elevation view of a conveyor system of the vehicle of FIG. 16, with the packer in the lowered configuration;

FIG. 20 is a top plan view of the conveyor system of FIG. 19, with the packer in the lowered configuration;

FIG. 21 is a perspective view, taken from a front, left side, of the conveyor system of FIG. 19, with the packer in the lowered configuration;

FIG. 22 is a close-up, left side elevation view of a front portion of the conveyor system of FIG. 19, with the packer in the lowered configuration and positioned near a front of the conveyor system;

FIG. 23 is a perspective view, taken from a rear, right side, of the conveyor system of FIG. 19, with the packer in a raised configuration;

FIG. 24 is a longitudinal cross-section of the vehicle of FIG. 16, with the packer in the raised configuration and positioned near the front of the conveyor system;

FIG. 25 is a longitudinal cross-section of the vehicle of FIG. 16, with the packer in the raised configuration and positioned near a center of the conveyor system;

FIG. 26 is a longitudinal cross-section of the vehicle of FIG. 16, with the packer in the raised configuration and positioned near a rear of the conveyor system;

FIG. 27 is a perspective view, taken from a front, left side, of an alternative embodiment of the vehicle of FIG. 1;

FIG. 28 is a longitudinal cross-section of the vehicle of FIG. 27;

FIG. 29 is a perspective view, taken from a front, left side, of a conveyor system of the vehicle of FIG. 27;

FIG. 30 is a perspective view, taken from a rear left side, of a motor and transmission of the conveyor system of FIG. 29; and

FIG. 31 is a flow chart illustrating a method for operating the vehicles of FIGS. 1, 7,10, 16 and 27.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

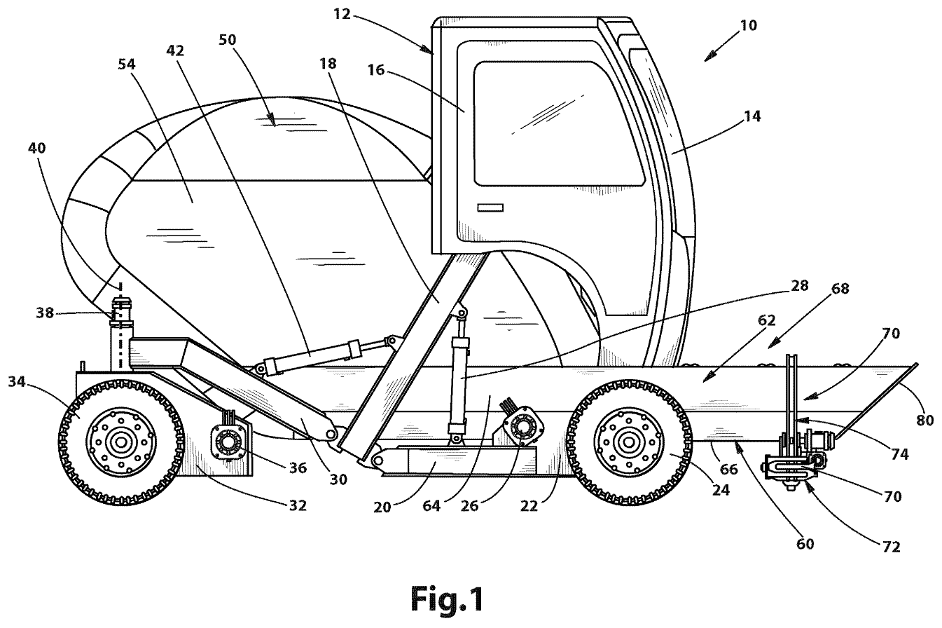

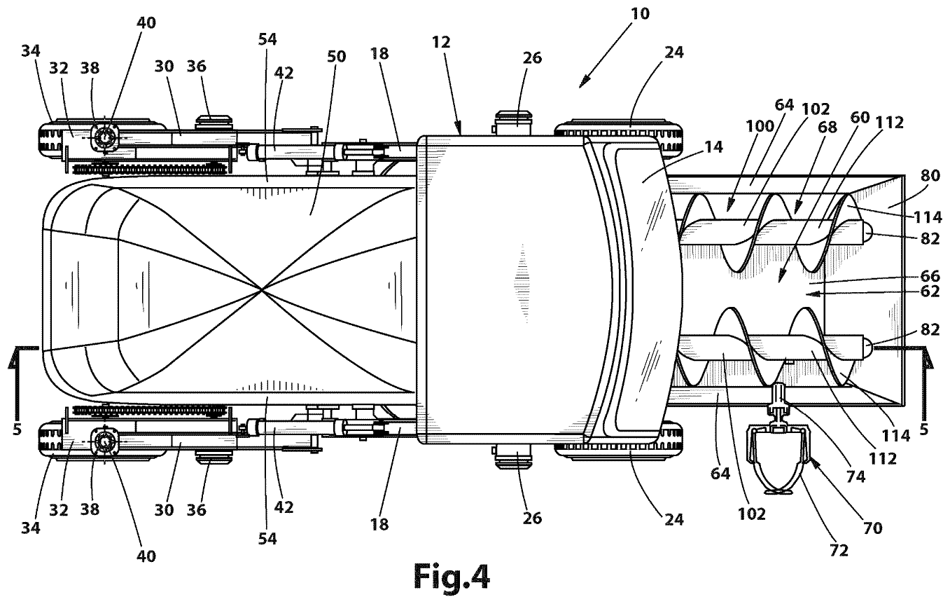

FIGS. 1 to 6 illustrate a waste collection vehicle 10 according to an embodiment of the present technology. The vehicle 10 has a cab 12. The cab 12 has a front windshield 14 and side doors 16 to permit ingress and egress from the cab 12. A seat; a steering wheel; accelerator and brake pedals; and control actuators such as button, switches, and touchscreens (all not shown) are provided inside the cab 12 to allow a driver of the vehicle 10 to operate the vehicle 10.

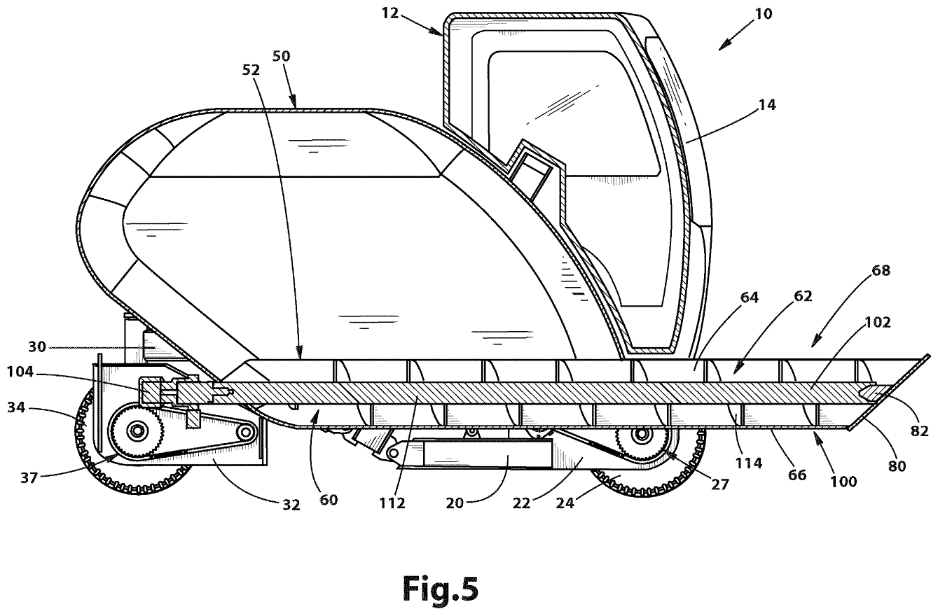

The cab 12 is connected to two diagonally extending frame members 18. Front swing arms 20 are pivotally connected to the front of the lower ends of the frame members 18 and extend forwardly from the lower ends of the frame members 18. For each swing arm 20, a front plate 22 is connected to the front end of the swing arm 20. Each front plate 22 has a front wheel 24 rotationally connected to a front portion thereof, and an electric motor 26 mounted thereto rearward of the front wheel 24. Each electric motor 26 is operatively connected to its corresponding front wheel 24 by a chain and sprocket assembly 27 (FIG. 5), or alternatively by a belt and pulley assembly or gears. A front hydraulic cylinder 28 connected to an accumulator (not shown) is pivotally connected between the frame member 18 and the swing arm 20 on each side of the vehicle 10 to define a front suspension assembly. It is contemplated that other types of front suspension assemblies could be provided.

Rear swing arms 30 are pivotally connected to the rear of the lower ends of the frame members 18 and extend rearwardly and upwardly from the lower ends of the frame members 18. For each swing arm 30, a rear plate 32 is pivotally connected to the rear end of the swing arm 20 so as to be disposed below the rear portion of the swing arm 30. Each rear plate 32 has a rear wheel 34 rotationally connected to a rear portion thereof, and an electric motor 36 mounted thereto forward of the rear wheel 34. Each electric motor 36 is operatively connected to its corresponding rear wheel 34 by a chain and sprocket assembly 37 (FIG. 5), or alternatively by a belt and pulley assembly or gears. Hydraulic motors 38 are mounted to the rear ends of the swing arms 30 and are connected to their corresponding rear plates 32. Each motor 38 pivots its corresponding plate about an axis 40, thereby steering its corresponding rear wheel 34 in order to steer the vehicle 10. A rear hydraulic cylinder 42 is pivotally connected between the frame member 18 and the swing arm 30 on each side of the vehicle 10 to define a rear suspension assembly. It is contemplated that other types of rear suspension assemblies could be provided.

The electric motors 26, 36 and the pumps of the hydraulic motors 38 are part of an electric power pack provided on the vehicle 10. The electric power pack additionally also includes a battery pack, a power electronics controller, a DC/DC converter (all not shown). It is contemplated that instead of having one electric motor 26 or 36 per wheel 24 or 34, that the vehicle 10 could have one electric motor driving both front wheels 24 and one electric motor driving both rear wheels 34. It is also contemplated that only the front wheels 24 or only the rear wheels 34 could be driven by an electric motor. It is also contemplated that in alternative embodiments, the wheels 24, 34 could be driven by an internal combustion engine. It is also contemplated that in alternative embodiments the rear wheels 34 could be steered via a rack and pinion steering system or another type of steering system. It is also contemplated that in alternative embodiments, the front wheels 24 could be steered instead of or in addition to the rear wheels 34. It is also contemplated that in some embodiments, the vehicle 10 could have only three wheels, in which case only one of the wheels could be driven by an electric motor, or more than four wheels.

The vehicle 10 also has a container 50 disposed in part behind the cab 12. As best seen in FIGS. 1 and 5, a front portion of the container 50 extends under a rear portion of the cab 12. It is contemplated that the container 50 could be disposed completely behind the cab 12. The container 50 defines a single lower 52 opening in a bottom wall thereof. It is contemplated that in other embodiments the container 50 could define more than one lower opening 52 in its bottom wall. The container 50 has no other openings providing access to an interior of the container 50 since, as will be described in more detail below, waste is loaded and unloaded from the container 50 via the lower opening 52. As such, there is no need for an opening closed by a door and for a mechanism used to tip the container 50 relative to the cab 12 that have to be used to unload waste from the container 50.

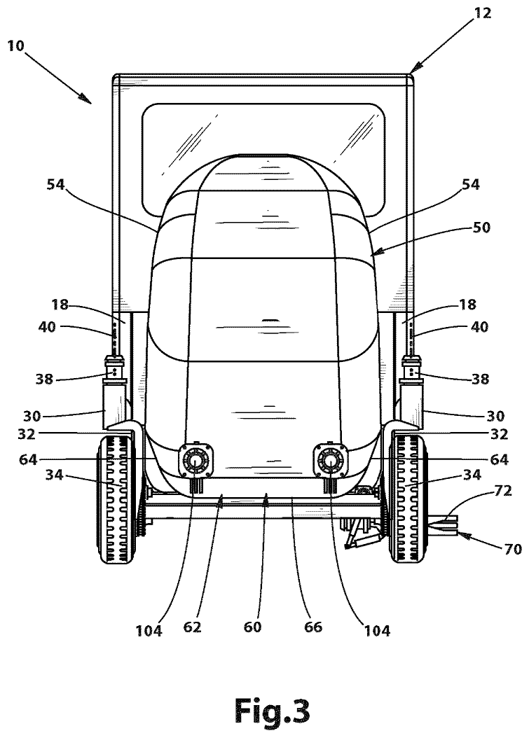

As seen in FIGS. 1, 3 and 5, a top of the container 50 is lower than a top of the cab 12. As a result, the vehicle 10 maintains a relatively low center of gravity even when the container 50 is full of waste. With reference to FIG. 3, it can be seen that the sidewalls 54 of the container 50 extend laterally inwardly as they extend upwardly. This inward angling of the sidewalls 54 helps ensure that waste present in the container 50 falls down through the lower opening 52 when waste is to be unloaded from the container 50. It is contemplated that in some embodiments the sidewalls 54 could extend vertically. As can also be seen in FIG. 3, a width of the container 50 is less than a lateral distance between the two rear wheels 34. This keeps the overall width of the vehicle 10 relatively small, thereby allowing the vehicle 10 to be maneuvered in small spaces such as alleys. As can also be seen, the container 50 has generally rounded features.

The container 50 is made of fiberglass or another type of fiber-reinforced plastic, thus making the container 50 resistant and lightweight. It is contemplated that other composite materials, plastics or metals could also be used to make the container 50.

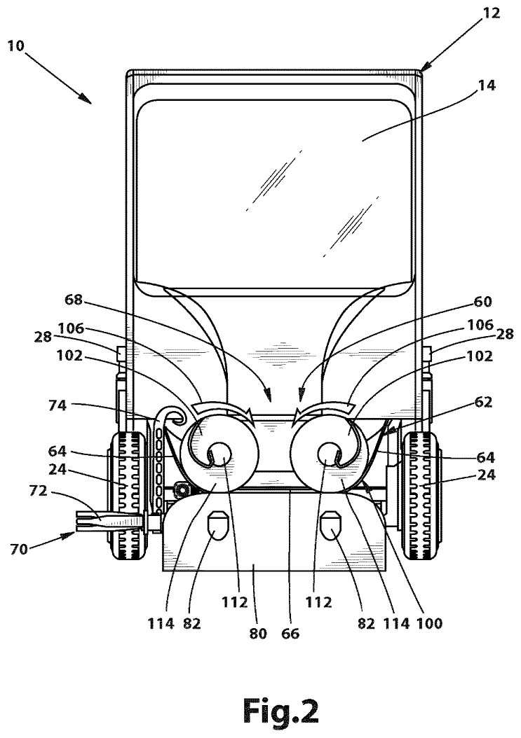

The vehicle 10 also has a longitudinally extending passageway 60. In the present embodiment, the passageway 60 is defined by a channel 62 having two sidewalls 64 and a bottom wall 66. With reference to FIGS. 2 and 3, it can be seen that the sidewalls 64 are angled such that the channel 62 tapers from top to bottom. As best seen in FIGS. 1 and 5, the passageway 60 extends under the container 50 and the cab 12. The top portions of the sidewalls 64 disposed under the container 50 are connected to the bottom of the container 50. As can also be seen, a portion of the passageway 60 extends forward of the cab 12. This portion of the passageway 60 defines a hopper 68 into which waste is dumped.

An automatic side loader (ASL) 70 is connected to the portion of the right sidewall 64 defining the hopper 68. The ASL 70 has a claw 72 for grabbing a waste container, such as a trash can, and a track 74 along which the claw 72 can travel to lift the waste container and empty it by gravity into the hopper 68. It is contemplated that the ASL 70 could alternatively be connected to the portion of the left sidewall 64 defining the hopper 68. It is also contemplated that the ASL 70 could be connected via beams and or brackets to the cab 12 or one of the frame members 18. It is also contemplated that the ASL 70 could be omitted, in which case the waste containers can be manually emptied in the hopper 68.

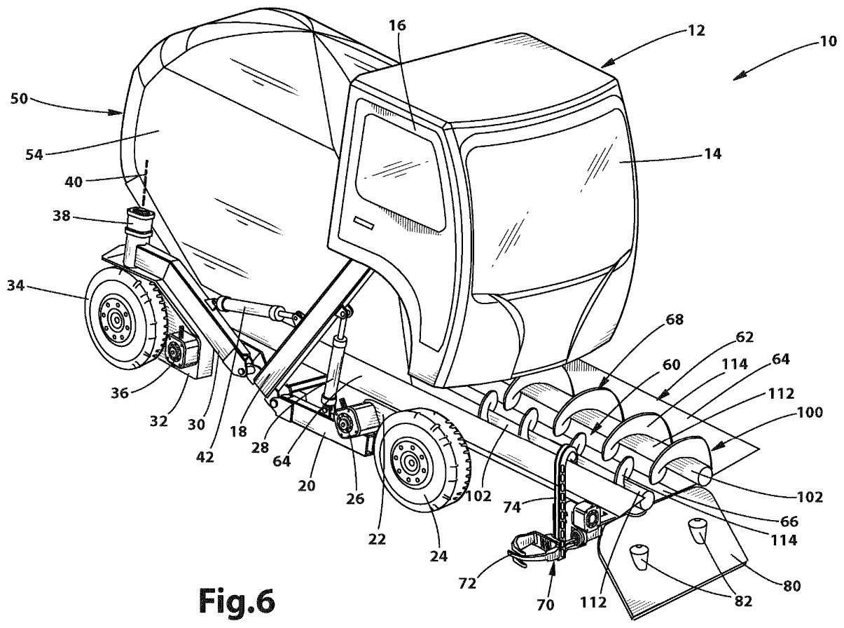

The front of the passageway 60 is opened and closed by a front gate 80. The front gate 80 is hinged at a bottom thereof to the bottom wall 66 of the channel 62. An electric actuator (not shown) moves the front gate 80 between its closed position (FIGS. 1, 4 and 5) and its opened position (FIGS. 2 and 6). In its closed position, the front gate is angled as can be seen in FIG. 1. It is contemplated that at least one latch, either operated manually or remotely, could be provided to help maintain the front gate 80 in the closed position. It is contemplated that the electric actuator could be replaced by another type of actuator such as a pneumatic actuator. It is also contemplated that no actuator could be provided, in which case the front gate 80 would be opened and closed manually. The front gate 80 and associated components are relatively light compared to a door provided on the back of the container and its associated components as in the prior art as the front gate 80 does not need to withstand the pressure of the waste present in the container as in the prior art arrangement. As can be seen in FIGS. 2, 5 and 6, two pegs 82 are connected to a rear side of the front gate 80 (i.e., the side of the front gate 80 facing rearwardly when the front gate 80 is closed). The function of the pegs 82 will be described in more detail below.

The vehicle 10 has a conveyor system 100 disposed at least in part in the passageway 60. The container 50, the passageway 60 and the conveyor system 100 together define a waste collection assembly. The conveyor system 100 can operate in two directions. In one direction, which is used to load the container 50 with waste, and with the front gate 80 closed, the conveyor system 100 conveys waste from the hopper 68, through the passageway 60 under the cab 12 and the container 50, and into the container 50 via the lower opening 52 of the container 50. In the other direction, and with the front gate 80 being open, the conveyor system 100 conveys waste received from the container 50 via the lower opening 52 of the container 50, through the passageway 60 under the container 50 and the cab 12, through the hopper 68 and out of the front of the passageway 60.

In the vehicle 10, the conveyor system 100 is an auger conveyor system 100. The auger conveyor system 100 has two augers 102 disposed in the passageway 60 and extending an entire length thereof. Each auger 102 has an electric motor 104 (FIGS. 3 and 5) connected to a rear end thereof for driving the auger 102. The electric motors 104 are disposed outside of the passageway 60, behind the channel 62. The electric motors 104 are powered by the battery pack of the electric power pack of the vehicle 10 described above. It is contemplated that a single electric motor 104 could be used to drive both augers 102. It is contemplated that the augers 104 could be driven by something other than an electric motor 104. The electric motors 104 drive the two augers 102 in opposite directions such that the two augers 102 are counter-rotating. To convey waste to the container 50, the augers 102 are rotated in the directions opposite to the directions indicated by arrows 106 in FIG. 2. To convey waste out of the container 50, the augers 102 are rotated in the directions indicated by the arrows 106 in FIG. 2.

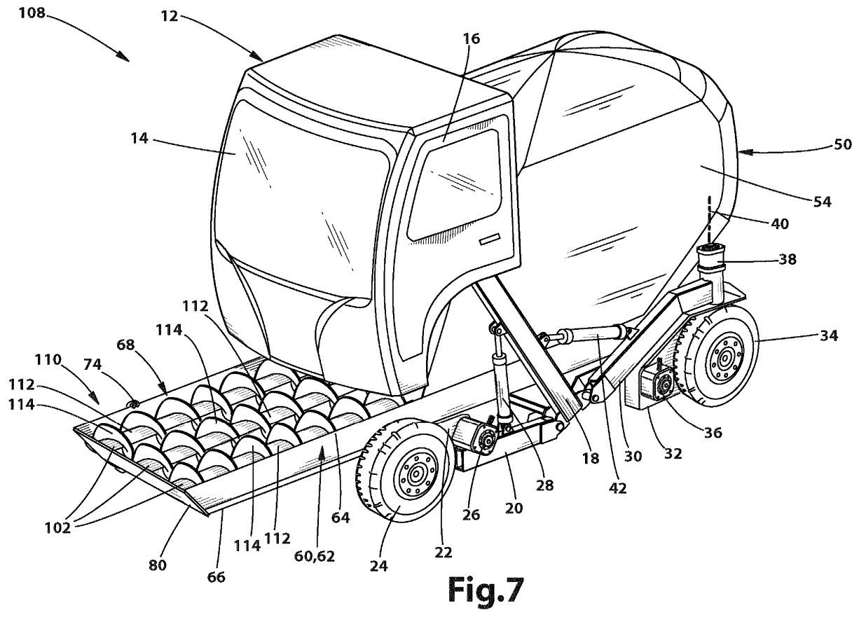

In an alternative embodiment shown in FIG. 7, a waste collection vehicle 108 has an auger conveyor system 110 with three augers 102. The container 50, the passageway 60 and the conveyor system 110 together define a waste collection assembly. Components of the waste collection vehicle 108 that are the same as or similar to the components of the waste collection vehicle 10 have been labeled with the same reference numerals in FIG. 7 and will not be described again. Auger conveyor systems having only one or more than three augers 102 are also contemplated.

Returning to the vehicle 10 shown in FIGS. 1 to 6, when the front gate 80 is closed, the pegs 82 are received in the front ends of the augers 102 to support the front ends of the augers 102 as best seen in FIG. 5. For auger conveyor systems having only one or more than two augers 102, a corresponding number of pegs 82 would be provided. As such, the pegs 82 act as an auger support. It is contemplated that other types of auger supports could be used for supporting front ends of the augers 102.

With reference to FIG. 5, each auger 102 has a hollow shaft 112. It is contemplated that the shaft 112 could be solid. The motor 104 is connected to the rear end of the shaft 112 and the peg 82 is received in the front end of the shaft 112 when the front gate 80 is closed. Each auger 102 also has a blade 114 wound around the shaft 112. As can be seen, the blade 114 has a uniform diameter at a front and center of the auger 102 but has a smaller diameter at the rear of the auger 102 where the blade 114 aligns with the lower opening 52 of the container 50. The blades 114 of the left and right augers 102 are wound around their respective shaft 112 in opposite directions.

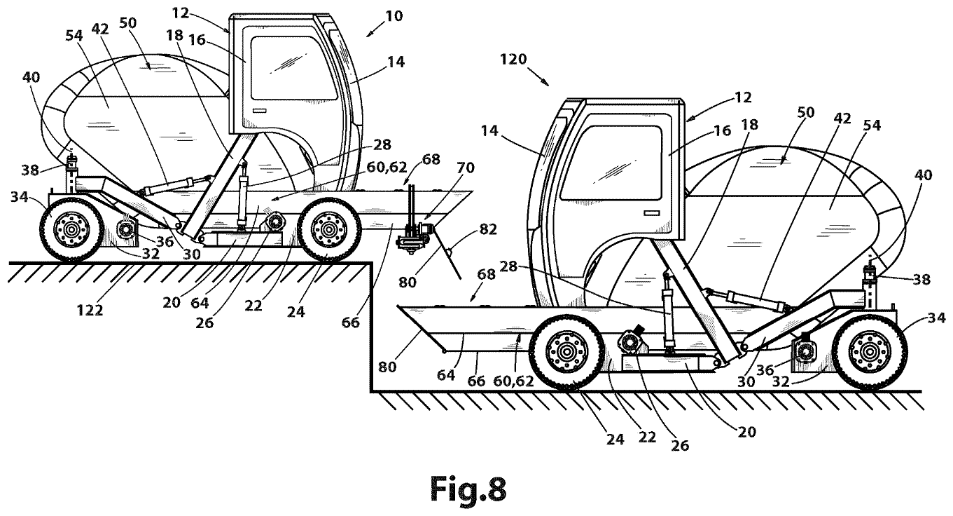

In one embodiment, the overall dimensions of the waste collection vehicle 10 are relatively small, which makes it convenient for collecting waste in residential areas and dense urban settings. However, this means that the container 50 can fill up relatively quickly. Instead of having the vehicle 10 return to a landfill site or a recycling plant, depending on the type of waste, which could be far away from the area where waste has been collected, it is contemplated that the vehicle 10 could empty the content of its container 50 into a larger waste collection vehicle, such as the waste collection vehicle 120 illustrated in FIG. 8. In the present embodiment, the vehicle 120 is larger in size than the vehicle 10, but generally has the same features. As such, components of the waste collection vehicle 120 that are similar to the components of the waste collection vehicle 10 have been labeled with the same reference numerals in FIG. 8 and will not be described again. When the container 50 of the vehicle 10 is full, the vehicle 10 drives onto a platform 122, or alternatively a ramp, such that the front end of its passageway 60 is disposed over the hopper 68 of the vehicle 120. Then, the front gate 80 of the vehicle 10 is opened and its conveyor system 100 is operated to convey waste from the container 50 out of the front of the passageway 60 as described above. The waste falls into the hopper 68 of the vehicle 120 which operates its conveyor system (not shown) to convey waste from its hopper 68 to its container 50. The vehicle 120 can be supplied with waste from multiple vehicle 10 operating in a given area before having to go empty its content in a landfill site or a recycling plant, depending on the type of waste. Although a vehicle 120 that is similar to the vehicle 10, but larger, is illustrated in FIG. 8, it is contemplated that a different type of waste collection vehicle could be used instead of the vehicle 120. It is also contemplated that the larger vehicle 120 could also be used to collect waste from waste containers directly. It is also contemplated that the vehicle 10 could empty the content of its container directly in a landfill site or a recycling plant, depending on the type of waste.

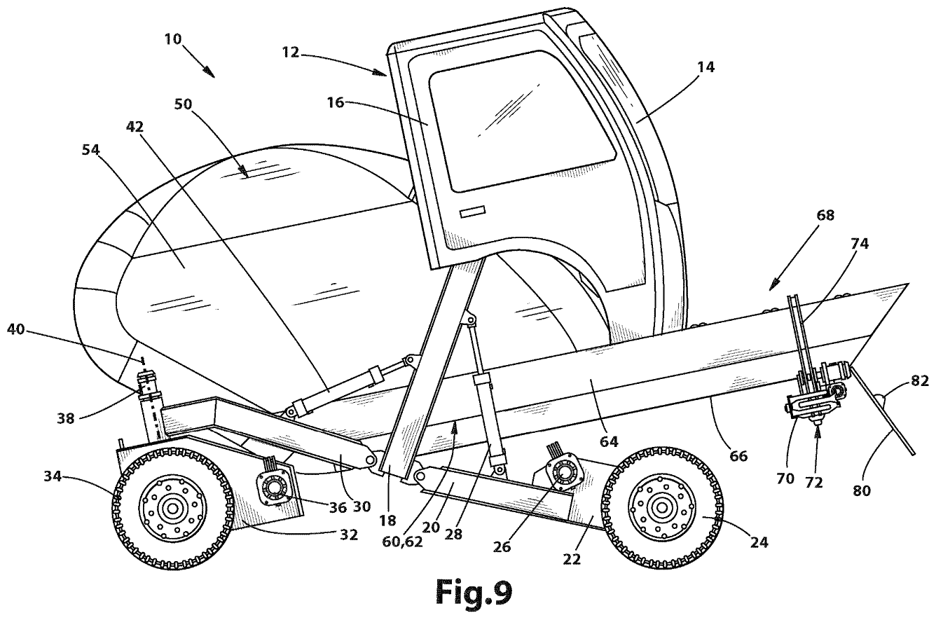

In an alternative embodiment illustrated in FIG. 9, the vehicle 10 can empty the content of its container 50 without having to drive onto a platform or a ramp. In such an embodiment, the hydraulic cylinders 28 of the front suspension assemblies are extended. As a result, the cab 12, the container 50, the passageway 60, the front gate 80 and the conveyor system 100 are all pivoted upwardly about the rear wheels 34 of the vehicle 10. As a result, the front of the passageway 60 can be lifted sufficiently high that the hopper 68 of the vehicle 120 (not shown in FIG. 9) can be received under the front of the passageway 60 of the vehicle 10, thus allowing the vehicle 10 to empty waste from its container 50 into the hopper 68 of the vehicle 120.

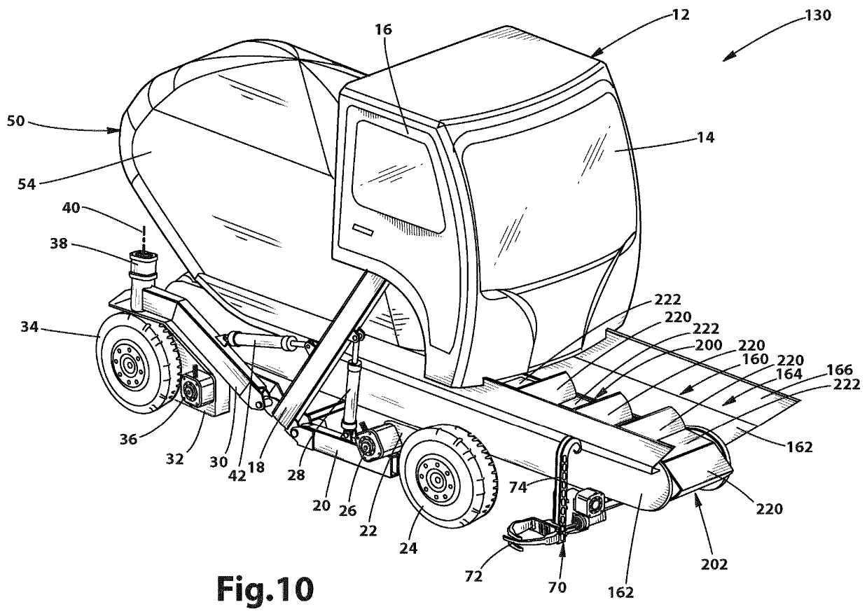

Turning now to FIGS. 10 to 15, a waste collection vehicle 130, which is an alternative embodiment of the waste collection vehicle 10 described above, will be described. For simplicity, components of the waste collection vehicle 130 that are the same as or similar to the components of the waste collection vehicle 10 have been labeled with the same reference numerals in the figures and will not be described again. In the waste collection vehicle 130, the longitudinally extending passageway 60 has been replaced by a longitudinally extending passageway 160 and the conveyor system 100 has been replaced by a conveyor system 200. The container 50, the passageway 160 and the conveyor system 200 together define a waste collection assembly.

With reference to FIG. 10, the passageway 160 is defined between two side walls 162. The passageway 160 extends under the container 50 and the cab 12. The top of the sidewall 162 disposed under the container 50 are connected to the bottom of the container 50. As can also be seen, a portion of the passageway 160 extends forward of the cab 12. This portion of the passageway 160 defines a hopper 164 into which waste is dumped. The front portion of left sidewall 162 defining the hopper 164 has a vertical extension 166 that deflects back in the hopper 164 waste being dumped by the ASL 70 that may overshoot the hopper 164. It is contemplated that the hopper 68 described above may also be provided with such a vertical extension 166. It is contemplated that a front gate similar to the front gate 80 could be provided to open and close the front of the passageway 160.

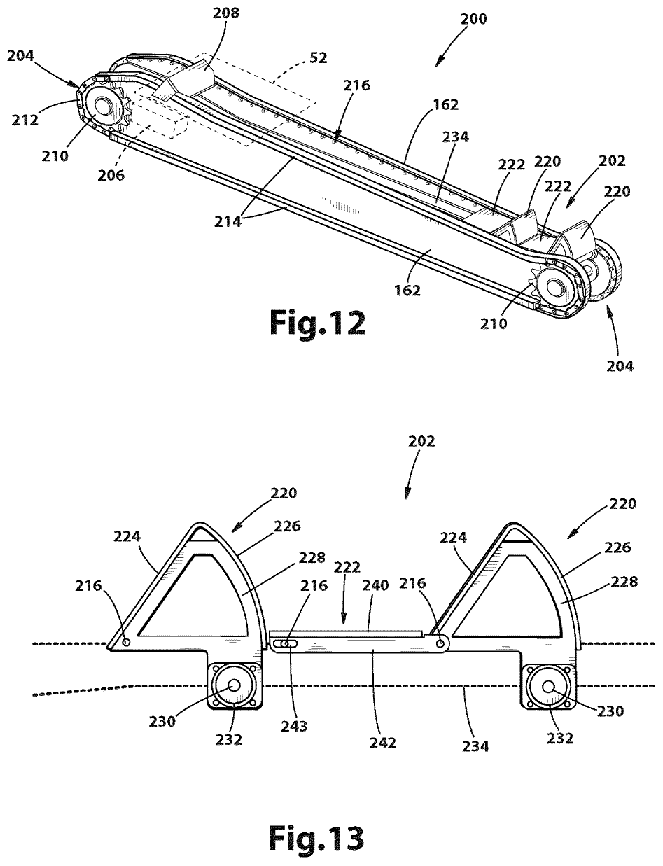

The conveyor system 200 includes a conveyor 202, left and right chain and sprocket assemblies 204 for driving the conveyor 202, and an actuator 206 (schematically shown in FIG. 12) for driving the chain and sprocket assemblies 204. In the present embodiment, the actuator 206 is an electric motor 206 powered by a battery pack of a power pack (not shown) similar to the electric power pack of the vehicle 10 described above, but other types of actuators are contemplated. The conveyor 202 and the electric motor 206 are disposed laterally between the side walls 162. The electric motor 206 is disposed vertically between the top and bottom parts of the conveyor 202 near a rear thereof. It is contemplated that the chain and sprockets assemblies 204 could be replaced by a different type of conveyor driving assembly, such as belt and sprocket assemblies.

The conveyor system 200 can operate in two directions. In one direction, which is used to load the container 50 with waste, the electric motor 206 drives the chain and sprocket assemblies 204, which drives the conveyor 202 such that the top of the conveyor 202 moves toward the back of the vehicle 130. In this direction, the conveyor system 200 conveys waste from the hopper 164, through the passageway 160 under the cab 12 and the container 50, and into the container 50 via the lower opening 52 of the container 50. To help direct waste into the container 50, a ramp 208 is disposed over the conveyor 202. The ramp 208 straddles the sidewalls 162, is connected to the sidewalls 162, and is aligned with a rear portion of the lower opening 52 as can be seen in FIG. 12. In the other direction, which is used to unload waste from the container 50, the electric motor 206 drives the chain and sprocket assemblies 204, which drives the conveyor 202 such that the top of the conveyor 202 moves toward the front of the vehicle 130. In this direction, the conveyor system 200 conveys waste received from the container 50 via the lower opening 52 of the container 50, through the passageway 160 under the container 50 and the cab 12, through the hopper 164 and out of the front of the passageway 160.

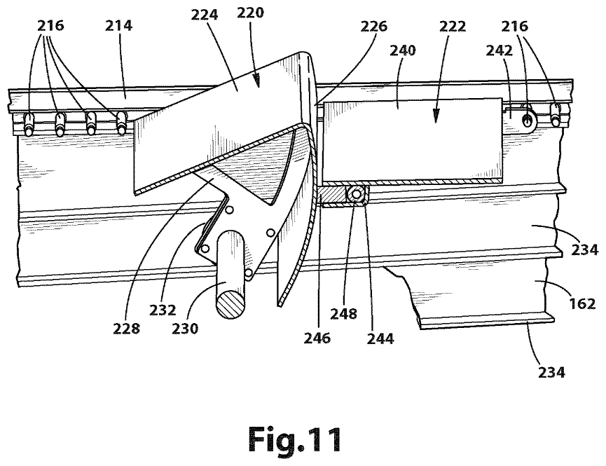

With reference to FIGS. 11 and 12, the chain and sprocket assemblies 204 will be described in more detail. The right chain and sprocket assembly 204 has front and rear sprockets 210 rotationally connected to the right side of the right sidewall 162 at a front and rear thereof. A chain 212 is looped around and driven by the sprockets 210. The chain 212 passes inside upper and lower channels 214 defined by the sidewall 162. The channels 214 act as guides for the chain 212. The electric motor 206 is operatively connected to the rear sprocket 210 to drive the rear sprocket 210, which then drives the chain 212. A plurality of pins 216 are connected to the left side of the chain 212 and extend laterally inwardly therefrom (best shown in FIG. 11 which shows the pins 216 of the chain 212 of the left chain and sprocket assembly 204). The pins 216 move together with the chain 212. The left chain and sprocket assembly 204 is mounted to the left sidewall 162 and is a mirror image of the right chain and sprocket assembly 204. As such, the left chain and sprocket assembly 204 will not be described in detail herein. Components of the left chain and sprocket assembly 204 corresponding to the components of the right chain and sprocket assembly 204 have been labeled with the same reference numerals in the figures.

Turning now to FIGS. 11 to 15, the conveyor 202 will be described in more detail. The conveyor 202 has steps 220 and slats 222 disposed in an alternating arrangement. In FIGS. 11 to 15, only some of the steps 220 and slats 222 of the conveyor 202 are illustrated, however it should be understood that the steps 220 and slates 222 form a closed loop. It is contemplated that in some embodiments, the conveyor 202 could have only steps 220 and no slats 222. It is contemplated that in some embodiments, the conveyor 202 could have only slats 222 and no steps 220. It is also contemplated that some embodiments, there could be more than one slat 222 between each pair of steps 220. It is also contemplated that different types of conveyors could be used.

The steps 220 and slats 222 will be described below with respect to their positions when they are located at the top of the conveyor 202. As such, it should be understood that a feature being described as being at the rear of the step 220 or slat 222 when at the top of the conveyor 202 will be at the front of the step 220 or slat 222 when at the bottom of the conveyor 202.

Each step 220 has a flat top surface 224 and an arcuate front surface 226 extending downward from the front of the top surface 224. Left and right sides frames 228 are connected between the left and right sides of the surfaces 224, 226. The side frame 228 each define an aperture through which and axle 230 extends. Wheels 232 are connected to the ends of the axle 230. The rear portion of each side frame 228 is pivotally connected to one of the pins 216 as can be seen in FIGS. 13 and 15.

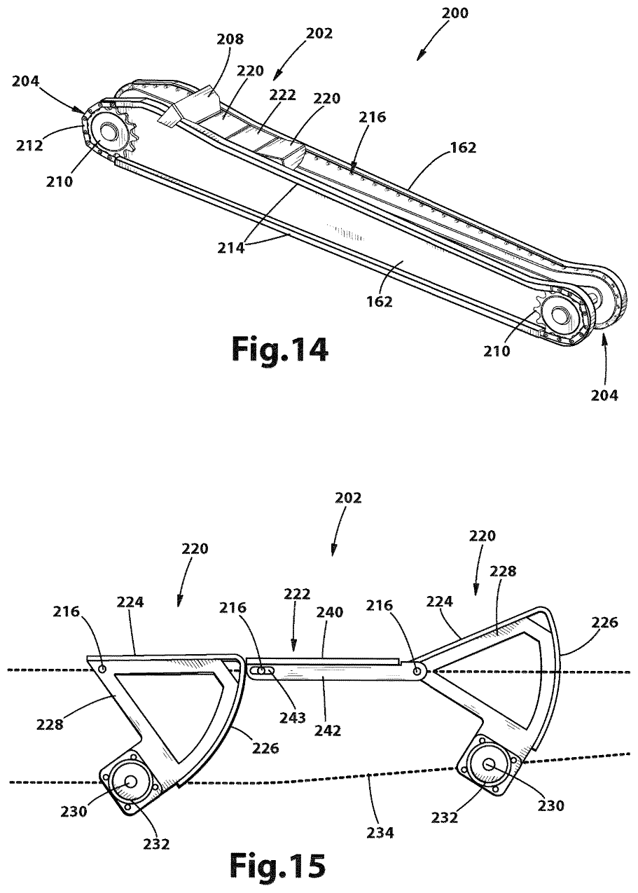

The left and right wheels 232 of the steps 220 roll inside left and right closed-loop tracks 234, the shape of which determine a position of the steps 220. The tracks 234 are defined on a laterally inner side of the sidewalls 162 and are schematically illustrated by a line in FIGS. 13 and 15. The steps 220 are movable between an extended position, shown in FIGS. 11 to 13, and a retracted position, shown in FIGS. 14 and 15 for the rearmost step 220 illustrated. As the steps 220 are moved around the tracks 234 by the chain and sprocket assemblies 204 and the electric motor 206, they will move between the extended and retracted positions. Where the tracks 234 are closest to the pins 216, the steps 220 are in their extended position, such as when the steps 220 are located in the hopper 164. Where the tracks 234 are furthest from the pins 216, the steps 220 are in their retracted position, such as when the steps 220 are located under the lower opening 52 of the container 50 and are about to pass under the ramp 208.

Each slat 222 has a flat top surface 240. The fronts of the left and right sides 242 of each slat 222 are pivotally connected to pins 216 as can be seen in FIGS. 11, 13 and 15. It the present embodiments, the pins 216 connected to the front of a slat 222 are the same pins 216 that are connected to the side frames 228 of a step 220 disposed directly in front of this slat 222. The rears of the left and right sides 242 of each slat 222 are pivotally connected to pins 216. As can be seen in FIGS. 13 and 15, the pins 216 at the rear of the slat 222 are received in slots 243. It is contemplated that the pins 216 at the front of the slat 222 could be received in slots in addition to or instead of the pins 216 at the rear being received in slots 243. As such, the slats 222 move around the tracks 234 together with the steps 220. However, the slats 222 do not move between extended and retracted positions like the steps 220. The top surface 240 of a slat 222 is generally level with a top surface 224 of the step 220 adjacent thereto when this step 220 is in the retracted position, as best seen in FIG. 15.

With reference to FIG. 11, each slat 222 has a bracket 244 at a rear thereof under the top surface 240. The bracket 244 holds a scraper 246 and biasing member 248. In the present embodiment, the biasing member 248 is a cylinder made of resilient materials, such as rubber for example, but alternatives are contemplated. For example, the biasing member 248 could be one or more springs. As can be seen, the bracket 244 extends from the rear side of the slat 222. The biasing member 248 biases the scraper 246 such that the rear end of the scraper 246 abuts against the arcuate front surface 226 of the step 220 located behind the slat 222. As a result, the scraper 246 scrapes waste that may have stuck to the arcuated front surface 226 as the step 220 moves from its extended position to its retracted position. The bracket 244, the scraper 246 and the biasing member 248 are not shown in FIGS. 13 and 15. It is contemplated that in some embodiments, the bracket 244, the scraper 246 and the biasing member 248 could be omitted from the slats 222.

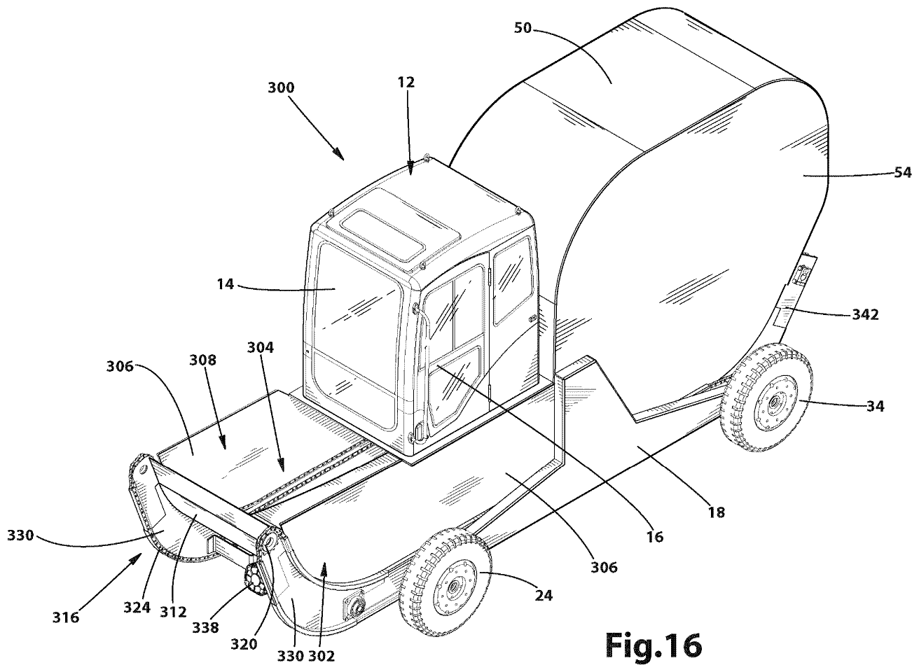

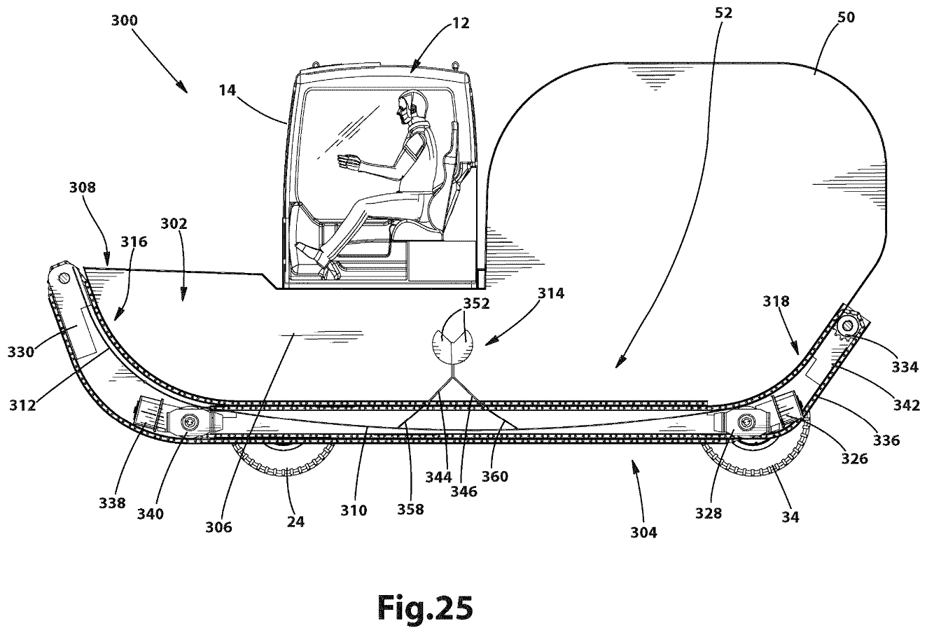

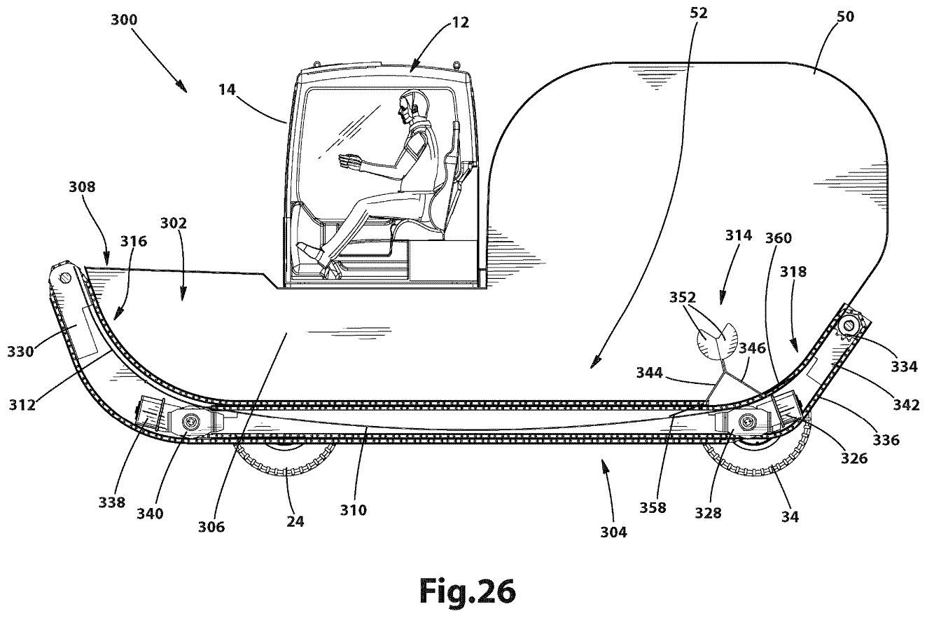

Turning now to FIGS. 16 to 26, a waste collection vehicle 300, which is an alternative embodiment of the waste collection vehicle 10 described above, will be described. For simplicity, components of the waste collection vehicle 300 that are the same as or similar to the components of the waste collection vehicle 10 have been labeled with the same reference numerals in the figures and will not be described again. In the waste collection vehicle 300, the longitudinally extending passageway 60 has been replaced by a longitudinally extending passageway 302 and the conveyor system 100 has been replaced by a conveyor system 304. The container 50, the passageway 302 and the conveyor system 304 together define a waste collection assembly.

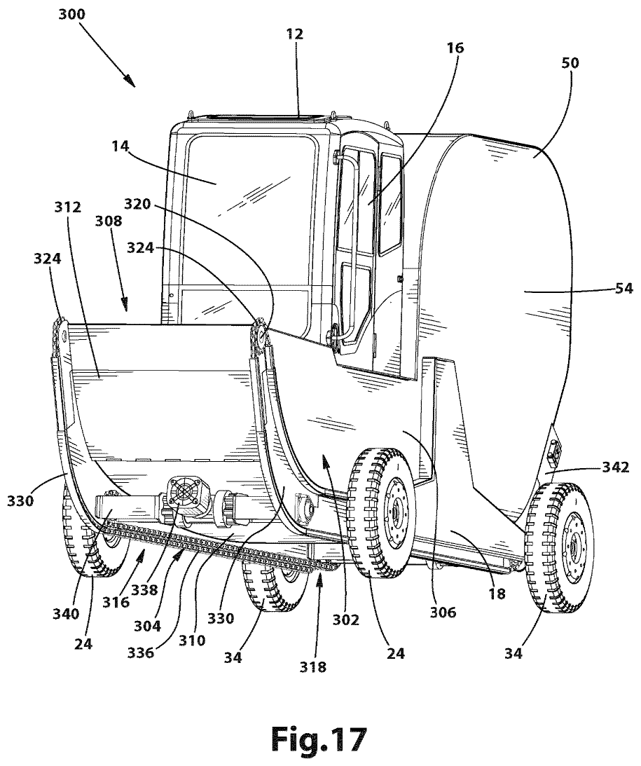

With reference to FIGS. 16 and 17, the passageway 302 is defined between two sidewalls 306. The passageway 302 also has a floor 310 disposed between the sidewalls 306. The passageway 302 extends under the container 50 and the cab 12. The sidewalls 306 are integrally formed with the sides 54 of the container 50, but it is contemplated that the sidewalls 306 could be separate parts connected to the container 50. As can also be seen, a portion of the passageway 302 extends forward of the cab 12. This portion of the passageway 302 defines a hopper 308 into which waste is dumped. It is contemplated that a front portion of one of the sidewalls 306 defining the hopper 308 could have an ASL connected thereto. A front gate 312 is provided to open and close the front of the passageway 302.

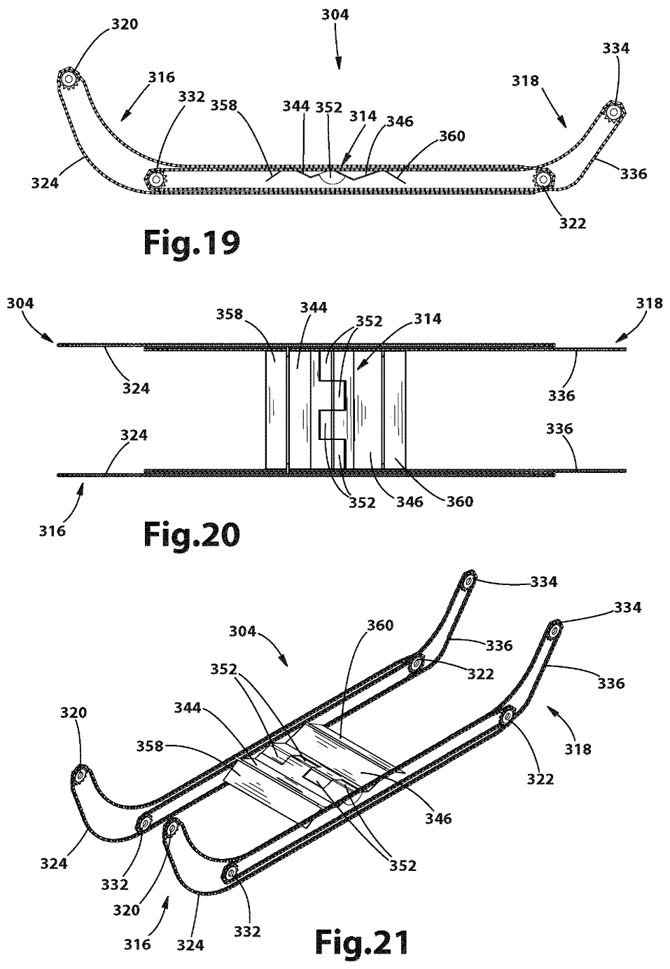

With reference to FIGS. 19 to 23, the conveyor system 304 includes a packer 314 operatively connected to a front drive assembly 316 and a rear drive assembly 318.

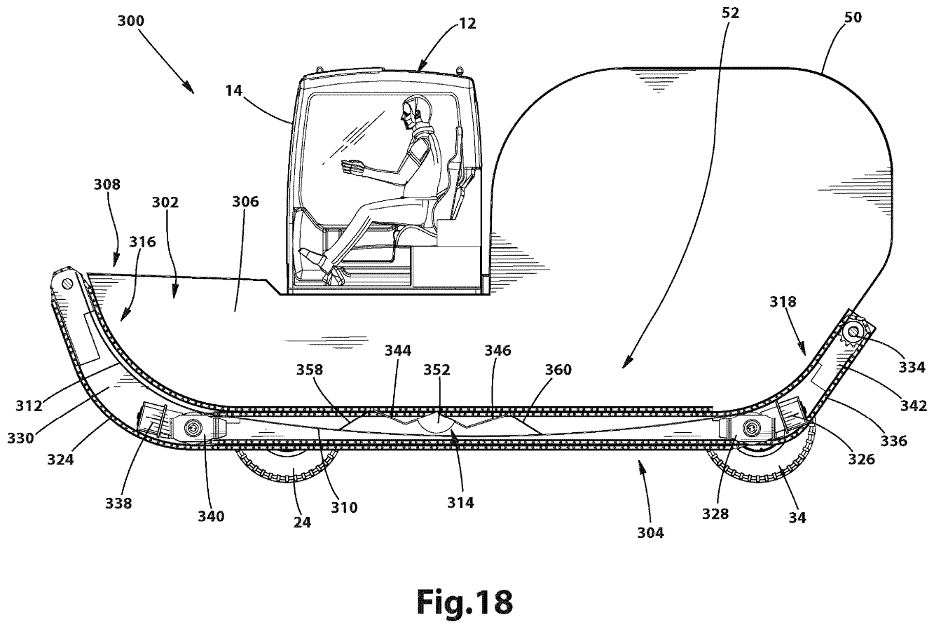

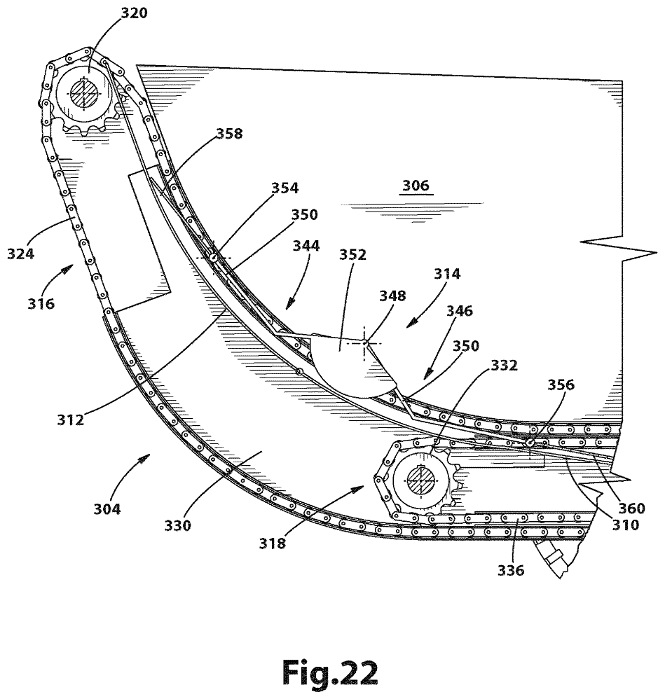

The front drive assembly 316 has left and right front sprockets 320, left and right rear sprockets 322, a left chain 324 engaging the left front and rear sprockets 320, 322, a right chain 324 engaging the right front and rear sprockets 320, 322, and an electric motor 326 operatively connected to the rear sprockets 322 via a gearbox 328 (FIG. 18) for driving the rear sprockets 322, and thereby the chains 324. It is contemplated that each rear sprocket 322 could be driven by a dedicated electric motor 326. It is also contemplated that the front drive assembly 316 could have only one front sprocket 320, one rear sprocket 322 and one chain 324 located at or near a lateral center of the passageway 302. As can be seen in FIG. 18, upper parts of the chains 324 are disposed above the floor 310 of the passageway 302 and lower parts of the chains 324 are disposed below the floor 310 of the passageway 302. The front sprockets 320 are disposed forward and vertically higher than the rear sprockets 322. As best seen in FIG. 22, the front portions of the chains 324 are received in chain guides 330 such that the front portions of the chains 324 are curved to generally follow a curvature of a front of the hopper 308. The rear and middle portions of the chains 324 extend horizontally.

The rear drive assembly 318 has left and right front sprockets 332, left and right rear sprockets 334, a left chain 336 engaging the left front and rear sprockets 332, 334, a right chain 336 engaging the right front and rear sprockets 332, 334, and an electric motor 338 operatively connected to the front sprockets 332 via a gearbox 340 (FIG. 17) for driving the front sprockets 332, and thereby the chains 336. It is contemplated that each front sprocket 332 could be driven by a dedicated electric motor 340. It is also contemplated that the rear drive assembly 318 could have only one front sprocket 332, one rear sprocket 334 and one chain 336 located at or near a lateral center of the passageway 302. As can be seen in FIG. 18, upper parts of the chains 336 are disposed above the floor 310 of the passageway 302 and lower parts of the chains 336 are disposed below the floor 310 of the passageway 302. The rear sprockets 334 are disposed rearward and vertically higher than the front sprockets 332. The rear sprockets 334 of the drive assembly 318 are also disposed rearward and vertically higher than the rear sprockets 322 of the drive assembly 316. The front sprockets 320 of the drive assembly 316 are disposed forward and vertically higher than the front sprockets 332 of the drive assembly 318. The front sprockets 332 of the drive assembly 318 are disposed forward of and at a same vertical level as the rear sprockets 322 of the drive assembly 316. As seen in FIG. 18, the rear portions of the chains 336 are received in chain guides 342 such that the rear portions of the chains 336 are curved to generally follow a curvature of a rear of the container 50. The rear and middle portions of the chains 336 extend horizontally. As best seen in FIG. 20, the chains 336 of the drive assembly 318 are disposed laterally inward of the chains 324 of the drive assembly 316, but the opposite is contemplated. As can be seen in FIG. 19, the chains 324 and 336 have portions disposed longitudinally and horizontally between the front sprocket 332 of the drive assembly 318 and the rear sprockets 322 of the drive assembly 316.

It is contemplated that the front and rear drive assemblies 316, 318 could be of a different type than the one described above, such as belt and sprocket assemblies.

With reference to FIG. 22, the packer 314 will be described in more detail. The packer 324 has a front portion 344 and a rear portion 346. The front and rear portions 344, 346 are hinged about an axis 348. Each of the front and rear portion 344, 346 has a bent body 350 and a pair of fingers 352 connected to the body 350 at the end of the body 350 than is hinged about the axis 348. Each of the fingers 352 has a cross-section shaped like a sector. The front end of the front portion 344 of the packer 314 is pivotally connected to the chains 324 of the drive assembly 316 about a pivot axis 354. The rear end of the rear portion 346 of the packer 314 is pivotally connected to the chains 336 of the drive assembly 318 about a pivot axis 356.

By driving the chains 324, 336 in the same direction and at the same speed, the packer 314 moves in the passageway 302. In one direction, the packer 314 moves toward the back of the vehicle 300 such that the packer 314 moves away from the hopper 308 and toward the opening 52 of the container 50. In the other direction, the packer 314 moves toward the front of the vehicle 300 such that the packer 314 moves away from the opening 52 of the container 50 toward the hopper 308.

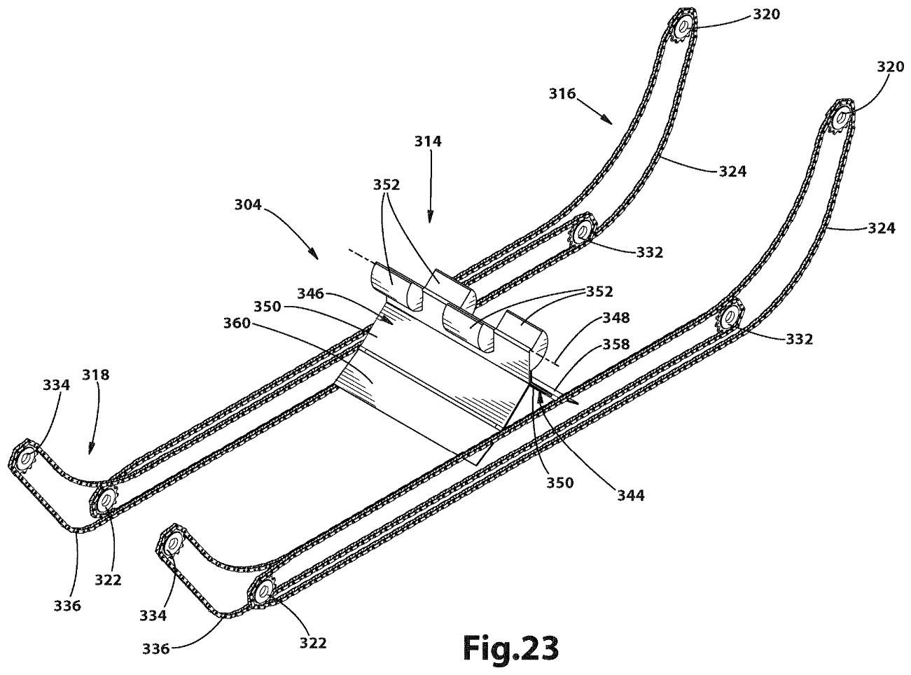

The packer 314 has a lowered configuration shown in FIGS. 18 to 22 and a raised configuration shown in FIGS. 23 to 26. In the raised configuration, the packer 314 conveys waste into or out of the container 50 as it moves in the passageway 302 as will be described below. In the lowered configuration, the packer 314 conveys no or at least less waste as it moves in the passageway 302. To change the packer 314 from the lowered configuration to the raised configuration, the electric motors 326, 338 drive the chains 324, 336, and therefore the portions 344, 346, in opposite directions such that the pivot axes 354, 356 move toward each other. To change the packer 314 from the raised configuration to the lowered configuration, the electric motors 326, 338 drive the chains 324, 336, and therefore the portions 344, 346, in opposite directions such that the pivot axes 354, 356 move away from each other. It is also contemplated that only one of the motor 326, 338 could be actuated to move the chains 324, 336, and therefore the portions 344, 346, relative to each other such that the pivot axes 354, 356 move relative to each other to change the packer 314 between the lowered and raised configurations.

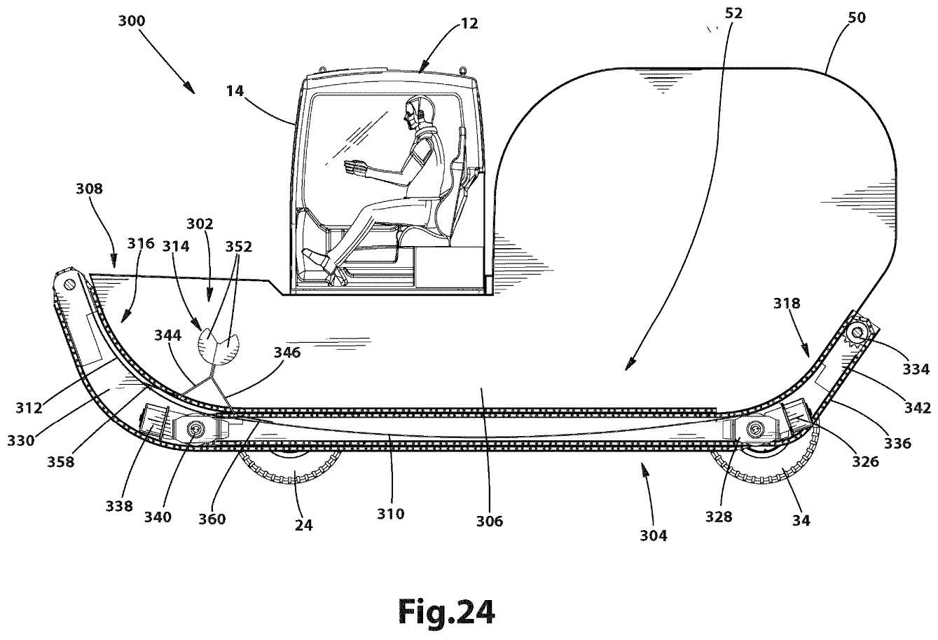

As can be seen in FIG. 22, to help prevent waste from becoming stuck under the packer 314 as the packer 314 moves in the passageway 302, a front scrapper 358 is pivotally connected to the front portion 344 of the packer 314 about the pivot axis 354 and a rear scrapper 360 is pivotally connected to the rear portion 346 of the packer 314 about the pivot axis 356. The free ends of the scrappers 358, 360 abut the floor 310 and follow the shape of the floor 310 as the packer 314 moves in the passageway 302, as can be seen in FIGS. 24 to 26.

To load the container 50 with waste, with the gate 312 closed, the drive assemblies 316, 318 are operated to first put the packer 314 in the lowered configuration, and to then move the packer 314 to its frontmost position in the hopper 308. Once waste is loaded in the hopper 308, the drive assemblies 316, 318 are operated to put the packer 314 in the raised configuration. The drive assemblies 316, 318 are then operated to move the packer 314 in the raised configuration toward the back of the vehicle 300. In this direction, the conveyor system 304 conveys waste from the hopper 308, through the passageway 302 under the cab 12 and the container 50, and into the container 50 via the lower opening 52 of the container 50.

To unload waste from the container 50, with the gate 312 open, the drive assemblies 316, 318 are operated to first put the packer 314 in the lowered configuration, and to then move the packer 314 to its rearmost position under the container 50. Once the packer 314 is in this position, the drive assemblies 316, 318 are operated to put the packer 314 in the raised configuration. The drive assemblies 316, 318 are then operated to move the packer 314 in the raised configuration toward the front of the vehicle 300. In this direction, the conveyor system 304 conveys waste received from the container 50 via the lower opening 52 of the container 50 through the passageway 302 under the container 50 and the cab 12, through the hopper 308 and out of the front of the passageway 302.

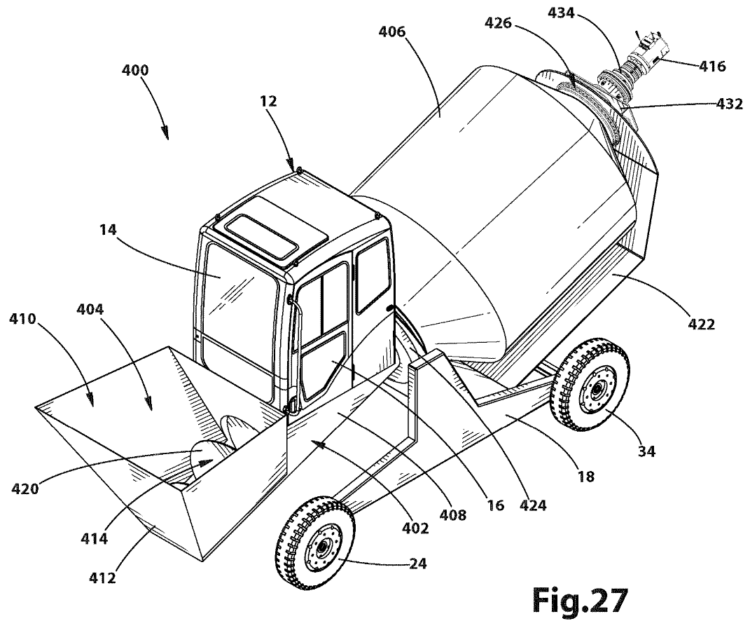

Turning now to FIGS. 27 to 30, a waste collection vehicle 400, which is an alternative embodiment of the waste collection vehicle 10 described above, will be described. For simplicity, components of the waste collection vehicle 400 that are the same as or similar to the components of the waste collection vehicle 10 have been labeled with the same reference numerals in the figures and will not be described again. In the waste collection vehicle 400, the longitudinally extending passageway 60 has been replaced by a passageway 402, the conveyor system 100 has been replaced by a conveyor system 404, and the container 50 has been replaced by a rotating container 406. The container 406, the passageway 402 and the conveyor system 404 together define a waste collection assembly.

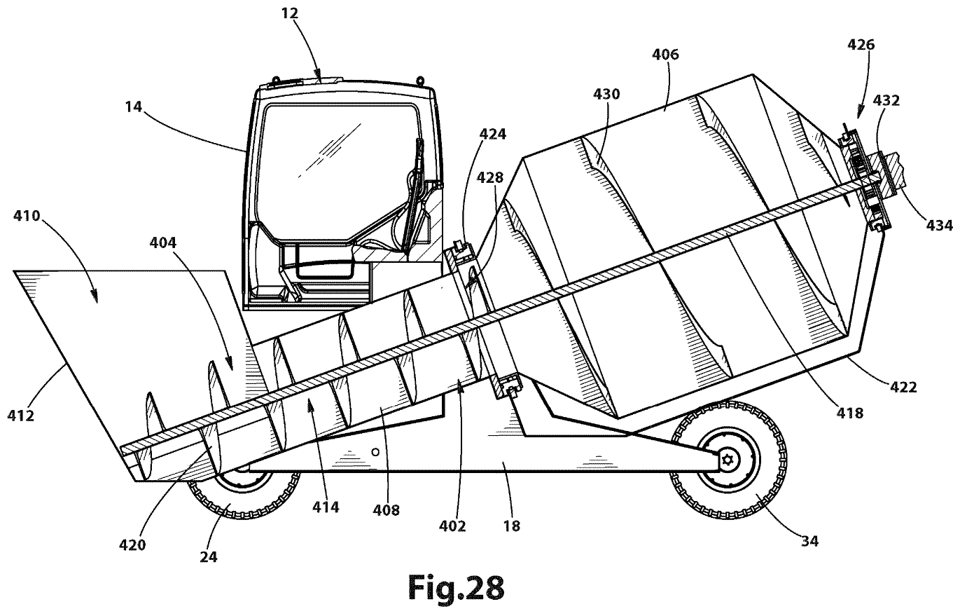

With reference to FIGS. 27 and 28, the passageway 402 has a cylindrical portion 408 that extends under the container 406 and the cab 12 and a front portion that extends forward of the cab 12 which defines a hopper 410 into which waste is dumped. It is contemplated that an ASL could be connected to a side of the hopper 420. A front gate 412 is provided to open and close the front of the passageway 402. As can be seen in FIG. 28, the passageway 402 extends upward as it extends rearward.

The conveyor system 404 is an auger conveyor system 404. The auger conveyor system 404 has a single auger 414 disposed in the passageway 402 and extending an entire length thereof. The auger 414 is driven by an electric motor 416 connected to a rear end thereof for driving the auger 414. The electric motor 416 is disposed behind the container 406. The electric motor 416 is powered by the battery pack of the electric power pack of the vehicle 400.

A bearing (not shown), rotationally supports the auger 414 in the passageway 420. It is contemplated that other types of auger supports could be used for supporting the auger 414.

The auger 414 has a hollow shaft 418. It is contemplated that the shaft 418 could be solid. The motor 416 is connected to the rear end of the shaft 418 as will be described in more detail below, and the peg is received in the front end of the shaft 418 when the front gate 412 is closed. As can be seen in FIG. 28, the shaft 418 is angled such that the rear end of the shaft 418 is vertically higher than the front end of the shaft 418. It is contemplated that in some embodiments the shaft 418 could be horizontal or at an angle other than the one illustrated. As can also be seen in FIG. 28, the shaft 418 extends in the container 406. The auger 414 also has a blade 420 wound around the shaft 418.

The rotating container 406 is a rotating drum 406 that is rotationally supported by a cradle 422. The cradle 422 is connected to the frame members 18. The drum 406 is made of fiberglass or another type of fiber-reinforced plastic, thus making the drum 406 resistant and lightweight. It is contemplated that other composite materials, plastics or metals could also be used to make the drum 406. The drum 406 is angled and rotates about the shaft 418 of the auger 414. The front end of the drum 406 is rotationally supported by the cradle 422 by via a bearing assembly 424. The rear end of the drum 406 is rotationally supported by the cradle 422 via a planetary gear system 426. The planetary gear system 426 will be described in more detail below. The drum 406 defines an opening 428 at the front thereof. As can be seen in FIG. 28, the drum 406 is angled, the opening 428 is inclined downward and, as such, is a lower opening 428. In alternative embodiments where the shaft 418 is horizontal, the drum 406 rotates about a horizontal axis and the opening 428 is a front opening 428. The drum 406 has an internal helical flange 430. As will be described below, the auger 414 and the drum 406 rotate in opposite directions. As such, the auger 414 and the internal helical flange 430 of the drum 406 have opposite handedness. It is contemplated that is some embodiments, the auger 414 and the drum 406 could rotate in a same direction, in which case the auger 414 and the internal helical flange 430 of the drum 406 would have the same handedness.

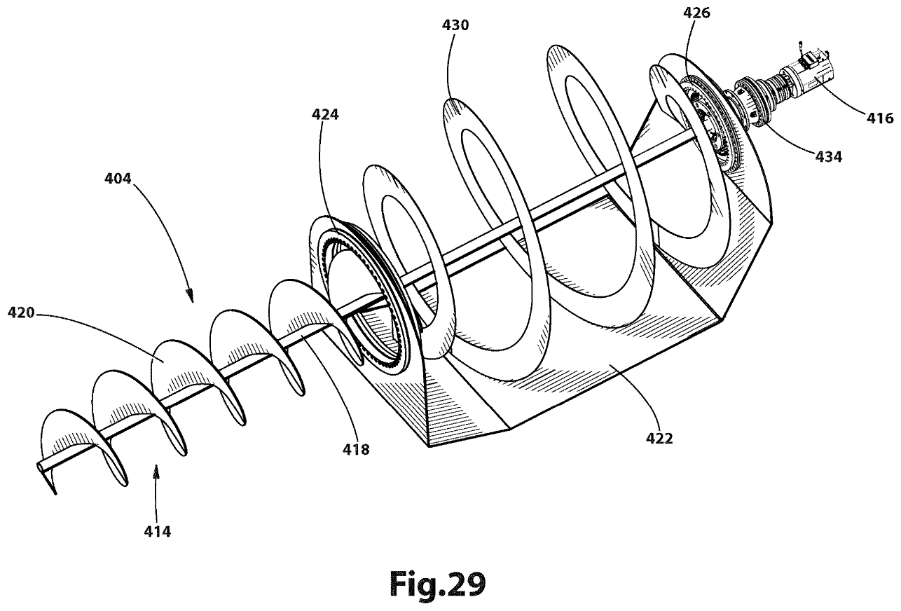

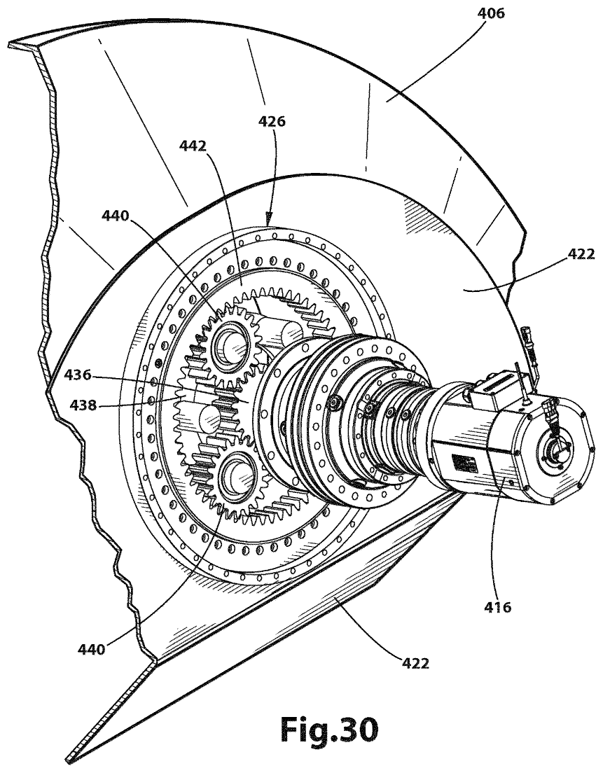

The electric motor 416 is mounted to the cradle 422 via a bracket 432 (shown in FIGS. 27, 28, omitted in FIGS. 29, 30) connected to the back of the cradle 422. As such, a housing of the motor 416 is rotationally fixed relative to the cradle 422. An output shaft (not shown) of the motor 416 is operatively connected to the rear end of the shaft 418 of the auger 414 via a gearbox 434.

With reference to FIG. 30, the planetary gear system 426 has a sun gear 436 that is mounted to the rear end of the shaft 418 of the auger 414 and rotates with the shaft 418. The planetary gear system 426 has a carrier 438 that is connected to the cradle 422 so as to be rotationally fixed. The planetary gear system 426 also has three planet gears 440 (only two of which are visible in FIG. 30) rotationally mounted to the carrier 438. The planetary gear system 426 also has a ring gear 442 fixed to the drum 406. The planet gears 440 engage the sun gear 436 and the ring gear 442 such that when the sun gear 436 and the shaft 418 are rotated in one direction by the motor 416, the ring gear 442 and the drum 406 rotate in the opposite direction. Also, as a result of the planetary gear system 426 operatively connecting the motor 416 to the drum 406, the auger 414 and the drum 406 rotate at different speeds. In the present embodiment, the auger 414 rotates four times faster than the drum 406, but other speed ratios are contemplated. It is contemplated that the motor 416 could drive the drum 406 via different mechanisms, including mechanisms where the auger 414 and the drum 406 rotate at a same speed and/or in the same direction. It is also contemplated that the motor 416 could only be used to drive the auger 414 and that a second motor or another actuator could be used to turn the drum 406.

The conveyor system 404 can operate in two directions. In one direction, which is used to load the container 406 with waste, and with the front gate 412 closed, the motor 416 turns the auger 414 clockwise (as viewed from the front end of the auger 414) and the drum 406 counter-clockwise, and the conveyor system 404 conveys waste from the hopper 410, through the passageway 408 under the cab 12, and into the container 406 via the lower opening 428 of the container 406. In the other direction, and with the front gate 412 being open, the motor 416 turns the auger 414 counter-clockwise (as viewed from the front end of the auger 414) and the drum 406 clockwise, and the conveyor system 404 conveys waste received from the container 406 via the lower opening 428 of the container 406, through the passageway 408 under the cab 12, through the hopper 410 and out of the front of the passageway 408.

It is contemplated that in alternative embodiments, a vehicle has a container and a conveyor system as described in one of the above embodiments, except that the passageway extends rearward from the container such that the hopper is disposed at the back of the vehicle. As a result, in such embodiments, waste is loaded and unloaded from the back of the vehicle.

It is also contemplated that in alternative embodiments, the above described waste collection waste assemblies consisting of a container, a passageway and a conveyor system could be provided separately from a vehicle having a cab. For example, the above waste collection assemblies could be provided on trailers to be towed by a propelled vehicle, or could be provided as stationary units that unload into other waste collection vehicles.

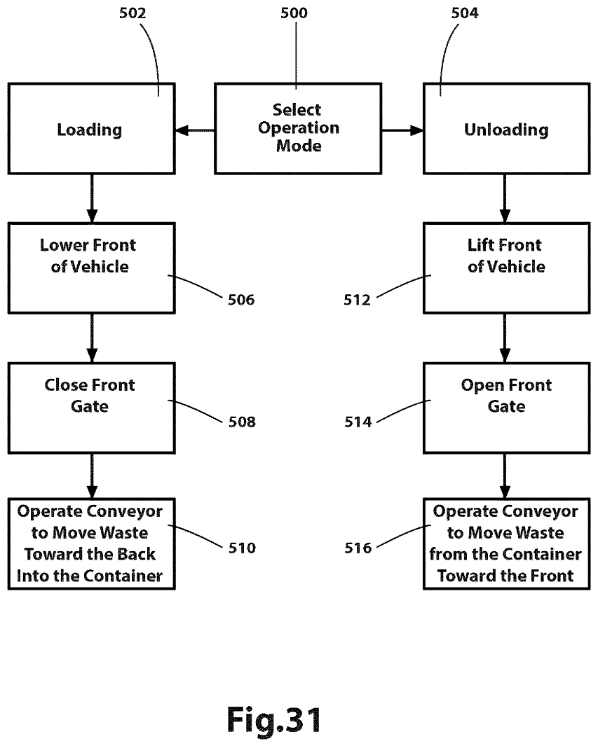

Turning now to FIG. 31, a method for operating a waste collection vehicle such as the vehicles 10, 108, 130, 300 and 400 will be described. The operator of the vehicle first selects at 500 an operation mode of a conveyor system of the vehicle. The operation mode is selected from a loading mode 502 and an unloading mode 504. In some embodiments, once the operation mode is selected, an indication of the selected mode is provided to the operator of the vehicle inside the cab. This could be done on a screen or by one or more lights provided inside the cab.

In response to selecting the loading mode 502, should the front of the vehicle be lifted as shown for the vehicle 10 in FIG. 9, the front of the vehicle is lowered at 506, for vehicles having this function. This can be done automatically in response to selecting the loading mode 502 or in response to an operation of the operator of the vehicle. Should the front of the vehicle already be lowered or for vehicles not provided with this functionality, step 506 is omitted.

Then at 508, the front gate is closed to close the front of the passageway. This can be done automatically in response to selecting the loading mode 502 or in response to an operation of the operator of the vehicle. Should the front gate already be closed or for vehicles not provided with a front gate, such as vehicle 130, step 508 is omitted.

Then at 510, the conveyor system operates in a first direction that conveys waste that has been put in the hopper toward a back of the vehicle by making waste pass under the cab, under the container and into the container via the lower opening of the container.

In response to selecting the unloading mode 504, should the front of the vehicle be lowered, the front of the vehicle is lifted at 512 as shown for the vehicle 10 in FIG. 9, for vehicles having this function. This can be done automatically in response to selecting the unloading mode 504 or in response to an operation of the operator of the vehicle. Should the front of the vehicle already be lifted or for vehicles not provided with this functionality or should the vehicle be unloaded using a platform as in FIG. 8 or a ramp, step 512 is omitted.

Then at 514, the front gate is opened to open the front of the passageway. This can be done automatically in response to selecting the unloading mode 504 or in response to an operation of the operator of the vehicle. Should the front gate already be opened or for vehicles not provided with a front gate, such as vehicle 130, step 514 is omitted.

Then at 516, the conveyor system operates in a second direction that conveys waste received from the container via the lower opening of the container toward a front of the vehicle by making waste pass under the container, under the cab, into the hopper, and out of a front of the vehicle.

It is contemplated that the waste collection vehicle could be provided with one or more sensors to indicate to the operator of the vehicle a level of waste in the container, or that the container is almost full of waste, such that the operator can know when the container should be unloaded.

Although not indicated above, in addition to having the loading and unloading operation modes, the conveyor system can also be stopped. This is used when the vehicle is travelling and does not need to load or unload waste for example.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A waste collection assembly comprising:
a container defining a lower opening;
a longitudinally extending passageway extending under the container, the passageway extending from the container, a portion of the passageway extending from the container defining a hopper; and
a conveyor system disposed at least in part in the passageway, the conveyor system being configured to operate in a first direction and in a second direction,
in the first direction, the conveyor system conveying waste from the hopper, through the passageway under the container, and into the container via the lower opening of the container,
in the second direction, the conveyor system conveying waste received from the container via the lower opening of the container, through the passageway under the container, through the hopper and out of an end of the passageway.

2. The waste collection assembly of claim 1, wherein the conveyor system is an auger conveyor system.

3. The waste collection assembly of claim 2, wherein the auger conveyor system comprises:
at least one auger disposed in the passageway; and
a motor operatively connected to an end of the at least one auger for driving the at least one auger.

4. The waste collection assembly of claim 3, wherein the at least one auger is two counter-rotating augers.

5. The waste collection assembly of claim 3, further comprising:
a gate operatively connected to the end the passageway for selectively opening and closing the end of the passageway; and
an auger support connected to an inner side of the gate;
wherein:
the end of the at least one auger operatively connected to the motor is a first end; and
the auger support supports a second end of the at least one auger when the gate is closed.

6. (canceled)

7. The waste collection assembly of claim 5, wherein the auger support is at least one peg received in the second end of the at least one auger when the gate is closed.

8. The waste collection assembly of claim 3, wherein a diameter of a blade of the at least one auger is smaller at a rear of the at least one auger than at a front of the at least one auger.

9. (canceled)

10. The waste collection assembly of claim 3, wherein:
the at least one auger is a single auger; and
the container and the auger rotate in opposite directions.

11-23. (canceled)

24. The waste collection assembly of claim 1, wherein the conveyor system comprises:
a packer; and
at least one drive assembly operatively connected to the packer for moving the packer in the passageway,
in the first direction, the at least one drive assembly moving the packer away from the hopper and toward the lower opening of the container, and
in the second direction, the at least one drive assembly moving the packer away from the lower opening of the container and toward the hopper.

25-31. (canceled)

32. The waste collection assembly of claim 1, further comprising a gate operatively connected to the end of the passageway for selectively opening and closing the end of the passageway.

33-40. (canceled)

41. A waste collection vehicle comprising:
a cab;
at least three wheels operatively connected to the cab;
a container disposed at least in part behind the cab, the container defining an opening;
a longitudinally extending passageway extending under the cab, the passageway extending forward of the cab, a portion of the passageway extending forward of the cab defining a hopper; and
a conveyor system disposed at least in part in the passageway, the conveyor system being configured to operate in a first direction and in a second direction,
in the first direction, the conveyor system conveying waste from the hopper, through the passageway under the cab, and into the container via the opening of the container,
in the second direction, the conveyor system conveying waste received from the container via the opening of the container, through the passageway under the cab, through the hopper and out of a front of the passageway.

42. The vehicle of claim 41, wherein:
the passageway extends under the container;
in the first direction, the conveyor system conveys waste from the hopper, through the passageway under the cab and the container, and into the container via the opening of the container;
in the second direction, the conveyor system conveys waste received from the container via the opening of the container, through the passageway under the container and the cab, through the hopper and out of the front of the passageway.

43. The vehicle of claim 41, wherein the conveyor system is an auger conveyor system.

44. The vehicle of claim 43, wherein the auger conveyor system comprises:
at least one auger disposed in the passageway; and
a motor operatively connected to a rear end of the at least one auger for driving the at least one auger.

45. (canceled)

46. The vehicle of claim 44, further comprising:
a front gate operatively connected to a front of the passageway for selectively opening and closing the front of the passageway; and
an auger support connected to a rear side of the front gate, the auger support supporting a front end of the at least one auger when the front gate is closed.

47-64. (canceled)

65. The vehicle of claim 41, wherein the conveyor system comprises:
a packer; and
at least one drive assembly operatively connected to the packer for moving the packer in the passageway,
in the first direction, the at least one drive assembly moving the packer away from the hopper and toward the opening of the container, and
in the second direction, the at least one drive assembly moving the packer away from the opening of the container and toward the hopper.

66-80. (canceled)

81. A method for operating a waste collection assembly, the waste collection assembly having a container defining a lower opening, the method comprising:
selecting an operation mode of a conveyor system of the waste collection assembly, the operation mode being selected from a loading mode and an unloading mode;
in response to selecting the loading mode, operating the conveyor system in the loading mode, in the loading mode:
the conveyor system operates in a first direction conveying waste from a hopper toward the container by making waste pass under the container and into the container via the lower opening of the container; and
in response to selecting the unloading mode, operating the conveyor system in the unloading mode, in the unloading mode:
the conveyor system operates in a second direction conveying waste received from the container via the lower opening of the container toward the hopper by making waste pass under the container, into the hopper, and out of the hopper.

82. The method of claim 81, further comprising:
closing a gate of the hopper prior to operating the conveyor system in the loading mode; and
opening the gate prior to operating the conveyor system in the unloading mode.

83. The method of claim 81, further comprising lifting an end of the waste collection assembly having the hopper prior to operating the waste collection assembly in the unloading mode.

84. The method of claim 81, further comprising putting waste in the hopper using an automatic side loader.

85-88. (canceled)
